(19) United States
(12) Patent Application Publication
(10) Pub. No.: US 2026/0346372 A1
(43) Pub. Date: Nov. 5, 2026

(54) ADDITIVE MANUFACTURING METHOD, ADDITIVE MANUFACTURING APPARATUS, METHOD FOR MANUFACTURING ADDITIVE MANUFACTURED OBJECT, AND ADDITIVE MANUFACTURED OBJECT

(71) Applicant: MITSUBISHI ELECTRIC CORPORATION, Tokyo (JP)

(72) Inventors: Daiji MORITA, Tokyo (JP); Chisako ODA, Tokyo (JP); Takafumi FUJII, Tokyo (JP); Takashi YUZAWA, Tokyo (JP); Motomichi YAMAMOTO, Hiroshima (JP); Keita MARUMOTO, Hiroshima (JP); Tamaki ITO, Hiroshima (JP)

(73) Assignee: MITSUBISHI ELECTRIC CORPORATION, Tokyo (JP)

(21) Appl. No.: 19/486,995

(22) PCT Filed: Jun. 13, 2023
(86) PCT No.: PCT/JP2023/021946

§ 371 Date: Nov. 24, 2025

(51) Int. Cl. B23K 26/342; B23K 26/211; B23K 35/02; B23K 35/28; B23K 103/10; B33Y 10/00; B33Y 30/00; B33Y 40/10; B33Y 70/10

(52) U.S. Cl. CPC B23K 26/342; B23K 26/211; B23K 35/0266; B23K 35/286; B33Y 10/00; B33Y 30/00; B33Y 40/10; B33Y 70/10; B23K 2103/10

(57) ABSTRACT

An additive manufacturing method includes a first flux application step, a first flux solidification step, a first layering step, and a second layering step. In the first flux application step, a liquid flux is applied to a base material made of metal containing iron. In the first flux solidification step, the liquid flux is heated to form a first flux layer. In the first layering step, a first aluminum-containing metal layer is layered obtained by irradiating a first wire made of metal containing aluminum fed onto the first flux layer and the first flux layer with a laser beam, melting and solidifying them. In the second layering step, after the formation of the first aluminum-containing metal layer, second aluminum-containing metal layers are layered obtained by irradiating a second wire made of metal containing aluminum fed onto an underlying layer with the laser beam, melting and solidifying it.

### FIELD

The present disclosure relates to an additive manufacturing method in which a three-dimensional additive manufactured object is manufactured by layering, on a surface of a base material made of metal, a metal material different from the base material, an additive manufacturing apparatus, and a method for manufacturing an additive manufactured object.

### BACKGROUND

In order to obtain a composite structure using dissimilar materials, dissimilar material joining is required. Taking a composite structure of an aluminum-based material and an iron-based material as an example, a very brittle Al—Fe-based intermetallic compound is generated at a joint interface therebetween. When the Al—Fe-based intermetallic compound is formed thick at the joint interface, the strength of the joint interface is significantly reduced. Therefore, it is necessary to join the aluminum-based material and the iron-based material in such a way that a thick Al—Fe-based intermetallic compound is not formed between the aluminum-based material and the iron-based material, but in general, it is difficult to obtain a three-dimensional composite structure of the aluminum-based material and the iron-based material in such a way that a thick Al—Fe-based intermetallic compound is not formed.

Patent Literature 1 discloses a dissimilar material joining method in which an aluminum-based material to be welded made of aluminum or an aluminum alloy and an iron-based material to be welded are welded. In the dissimilar material joining method described in Patent Literature 1, the iron-based material to be welded has a zinc-based coating layer made of zinc or a zinc alloy with which a surface thereof is coated, and the aluminum-based material to be welded has a layer of a flux applied to at least a portion to be joined to the iron-based material to be welded. In the dissimilar material joining method described in Patent Literature 1, two materials to be welded are joined, by a melt welding method, in a state where the two materials to be welded are overlapped, with the aluminum-based material to be welded being disposed on a torch side. Consequently, a heated portion of the aluminum-based material to be welded is melted by heat from a heat source, and the flux is melted. The molten flux is added to a melted portion of the aluminum-based material to be welded, and only the zinc-based coating layer on the surface of the iron-based material to be welded is removed by a thermal reaction due to melting heat. As a result, the wettability of the surface of the iron-based material to be welded is improved in the melted portion, and the surface of the iron-based material to be welded is smoothly covered with the molten aluminum alloy. Consequently, the aluminum-based material to be welded and the iron-based material to be welded firmly adhere to each other, and a strong interfacial joining force is obtained.

### CITATION LIST

### Patent Literature

Patent Literature 1: WO 2007/058257 A1

### SUMMARY OF INVENTION

### Problem to Be Solved by the Invention

However, the technique described in Patent Literature 1 is a technique with which a plate-shaped iron-based material to be welded and a plate-shaped aluminum-based material to be welded are joined by welding. Therefore, in a case where the iron-based material to be welded has a plate shape, it is easy to form the zinc-based coating layer on the iron-based material to be welded having a plate shape. As one of methods for joining different types of metals to each other, there is an additive manufacturing method for manufacturing a three-dimensional additive manufactured object by feeding, onto a base material made of metal, a wire made of a metal material different from the base material, and layering a deposited layer obtained by melting and solidifying a metal wire and an underlying layer. The technique described in Patent Literature 1 cannot be applied to the additive manufacturing method, which is a problem. Specifically, in the additive manufacturing method, in a case where a base material made of metal containing iron is manufactured by the additive manufacturing method, the base material may be manufactured by melting a wire, and thus it is difficult to form a zinc-based coating layer on the surface of the base material similarly to the technique described in Patent Literature 1. Therefore, a technique has been required with which the iron-based material and the aluminum-based material are joined in the additive manufacturing method in such a way that the strength of the joint interface between the iron-based material and the aluminum-based material is not significantly reduced.

The present disclosure has been made in view of the above, and an object thereof is to provide an additive manufacturing method capable of realizing stronger joining than before at a joint portion of different materials of an iron-based material and an aluminum-based material.

### Means to Solve the Problem

In order to solve the above-described problem and achieve the object, an additive manufacturing method according to the present disclosure includes a first flux application step, a first flux solidification step, a first layering step, and a second layering step. In the first flux application step, a liquid flux is applied to a base material made of metal containing iron. In the first flux solidification step, the liquid flux applied to the base material is heated to form a first flux layer which is a layer of the liquid flux that has been solidified. In the first layering step, a first aluminum-containing metal layer is layered which is a layer obtained by irradiating a first wire which is a wire made of metal containing aluminum fed onto the first flux layer and the first flux layer with a laser beam, melting the first flux layer and the first wire, and solidifying the first flux layer and the first wire. In the second layering step, after the formation of the first aluminum-containing metal layer, one or more second aluminum-containing metal layers are layered which are layers obtained by irradiating a second wire which is a wire made of metal containing aluminum fed onto an underlying layer with the laser beam, melting the second wire, and solidifying the second wire,

### Effects of the Invention

The additive manufacturing method according to the present disclosure achieves an effect that it is possible to realize stronger joining than before at a joint portion of different materials of an iron-based material and an aluminum-based material.

### BRIEF DESCRIPTION OF DRAWINGS

FIG. 1 is a diagram schematically illustrating an example of a configuration of an additive manufacturing apparatus according to a first embodiment.

FIG. 2 is a block diagram illustrating an example of a hardware configuration of a control device included in the additive manufacturing apparatus according to the first embodiment.

FIG. 3 is a flowchart illustrating an example of a procedure of an additive manufacturing method according to the first embodiment.

FIG. 4 is a perspective view schematically illustrating an example of the procedure of the additive manufacturing method according to the first embodiment.

FIG. 5 is a perspective view schematically illustrating an example of the procedure of the additive manufacturing method according to the first embodiment.

FIG. 6 is a perspective view schematically illustrating an example of the procedure of the additive manufacturing method according to the first embodiment.

FIG. 7 is a perspective view schematically illustrating an example of the procedure of the additive manufacturing method according to the first embodiment.

FIG. 8 is a perspective view schematically illustrating an example of the procedure of the additive manufacturing method according to the first embodiment,

FIG. 9 is a diagram schematically illustrating an example of a configuration of an additive manufacturing apparatus according to a second embodiment.

FIG. 10 is a flowchart illustrating an example of a procedure of an additive manufacturing method according to the second embodiment.

FIG. 11 is a diagram schematically illustrating an example of a configuration of an additive manufacturing apparatus according to a third embodiment.

FIG. 12 is a flowchart illustrating an example of a procedure of an additive manufacturing method according to the third embodiment.

FIG. 13 is a diagram schematically illustrating another example of a configuration of an additive manufacturing apparatus according to the third embodiment.

FIG. 14 is a diagram schematically illustrating an example of a configuration of an additive manufacturing apparatus according to a fourth embodiment.

FIG. 15 is a diagram schematically illustrating an example of a configuration of an additive manufacturing apparatus according to a fifth embodiment.

FIG. 16 is a flowchart illustrating an example of a procedure of an additive manufacturing method according to the fifth embodiment.

FIG. 17 is a diagram schematically illustrating an example of a configuration of an additive manufacturing apparatus according to a sixth embodiment.

FIG. 18 is a flowchart illustrating an example of a procedure of an additive manufacturing method according to the sixth embodiment.

FIG. 19 is a diagram schematically illustrating an example of a configuration of an additive manufacturing apparatus according to a seventh embodiment.

FIG. 20 is a flowchart illustrating an example of a procedure of an additive manufacturing method according to the seventh embodiment.

FIG. 21 is a diagram schematically illustrating an example of a configuration of an additive manufacturing apparatus according to an eighth embodiment.

FIG. 22 is a flowchart illustrating an example of a procedure of an additive manufacturing method according to the eighth embodiment.

FIG. 23 is a flowchart illustrating an example of a procedure of the additive manufacturing method according to the eighth embodiment.

FIG. 24 is a diagram schematically illustrating an example of a configuration of an additive manufacturing apparatus according to a ninth embodiment.

FIG. 25 is a flowchart illustrating an example of a procedure of an additive manufacturing method according to the ninth embodiment.

FIG. 26 is a diagram schematically illustrating an example of a configuration of an additive manufacturing apparatus according to a tenth embodiment.

FIG. 27 is a block diagram illustrating an example of a configuration of a learning device in the additive manufacturing apparatus according to the tenth embodiment.

FIG. 28 is a diagram illustrating an example of machining point positional relationship information.

FIG. 29 is a diagram schematically illustrating an example of a neural network used by a model generation unit in FIG. 27.

FIG. 30 is a flowchart illustrating an example of a procedure of a learning process performed by the learning device of the additive manufacturing apparatus according to the tenth embodiment.

FIG. 31 is a diagram schematically illustrating an example of a configuration of an inference device in the additive manufacturing apparatus according to the tenth embodiment.

FIG. 32 is a flowchart illustrating an example of a procedure of an inference process performed by the inference device of the additive manufacturing apparatus according to the tenth embodiment.

FIG. 33 is a block diagram illustrating an example of a hardware configuration that realizes the learning device and the inference device in the additive manufacturing apparatus according to the tenth embodiment.

### DESCRIPTION OF EMBODIMENTS

Hereinafter, an additive manufacturing method, an additive manufacturing apparatus, and a method for manufacturing an additive manufactured object according to each embodiment of the present disclosure will be described in detail with reference to the drawings.

### First Embodiment

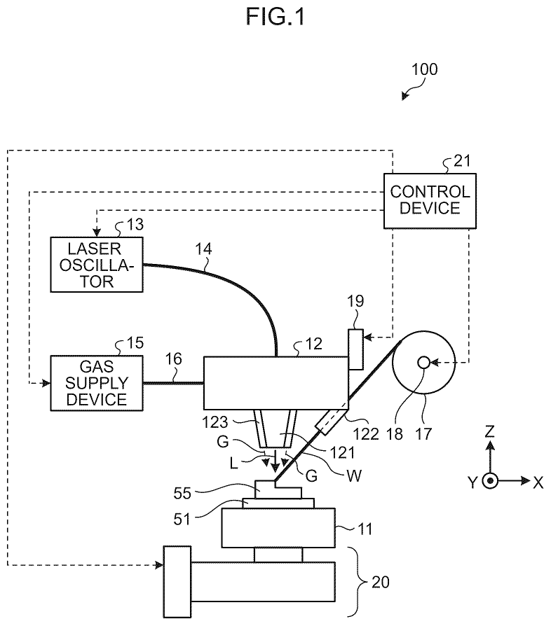

FIG. 1 is a diagram schematically illustrating an example of a configuration of an additive manufacturing apparatus according to a first embodiment. An additive manufacturing apparatus 100 is a machine tool that manufactures an additive manufactured object in a three-dimensional shape by adding a molten material to a workpiece. Hereinafter, a vertical direction is defined as a Z-axis direction, and two directions orthogonal to each other in a plane perpendicular to the Z-axis direction are defined as an X-axis direction and a Y-axis direction. In the first embodiment, a beam is a laser beam L. The material is a wire W made of metal. Specifically, the wire W made of metal is a wire W made of metal containing aluminum, and is a wire W made of aluminum, an aluminum alloy, or the like. In one example, the wire W made of metal is a wire W made of an aluminum-magnesium-based 5000-series aluminum alloy, an aluminum-silicon-based 4000-series aluminum alloy, or an aluminum-magnesium-silicon-based 6000-series aluminum alloy. Hereinafter, a material made of metal containing aluminum is referred to as an aluminum-based material, and the wire W made of metal containing aluminum is also referred to as an aluminum-based wire.

The additive manufacturing apparatus 100 forms a deposit 55 by stacking layers obtained by disposing unit beads which are solidified products of a molten material in parallel, thereby manufacturing an additive manufactured object in a three-dimensional shape. The additive manufactured object refers to the deposit 55 obtained by completing addition of a material in accordance with a machining program. The additive manufacturing apparatus 100 forms the deposit 55 on a base material 51.

The additive manufacturing apparatus 100 includes a stage 11, a machining head 12, a laser oscillator 13, a fiber cable 14, a gas supply device 15, a pipe 16, a wire spool 17, a rotary motor 18, a head drive device 19, a rotation mechanism 20, and a control device 21.

The base material 51 serving as a base for forming the deposit 55 is placed on the stage 11. In the example illustrated in FIG. 1, the base material 51 is a plate material made of metal containing iron. In one example, the base material 51 is made of austenitic stainless steel which is an iron alloy containing chromium and nickel. Hereinafter, a material made of metal containing iron is referred to as an iron-based material. FIG. 1 illustrates a case where the base material 51 is a plate material, but this is merely an example, and the base material 51 may be a material other than the plate material. In one example, the base material 51 may be a workpiece in which unit beads obtained by melting and solidifying a wire made of the iron-based material are stacked. In the following description, the workpiece is a target for formation of a unit bead which is a solidified product of a molten material, and refers to the base material 51, or the base material 51 on which the deposit 55 is formed.

The machining head 12 feeds the wire W made of metal to a machining point which is an irradiation position of the laser beam L, performs irradiation with the laser beam L, and injects a shielding gas G. The machining head 12 is movable with respect to the stage 11. The machining head 12 includes a beam nozzle 121, a wire nozzle 122, and a gas nozzle 123. The beam nozzle 121 emits the laser beam L toward the machining point. The laser beam L is a heat source that melts the wire W at the machining point. The wire nozzle 122 advances the wire W toward the machining point. The gas nozzle 123 injects the shielding gas G toward the machining point. An example of the shielding gas G is an inert gas such as nitrogen or argon. The additive manufacturing apparatus 100 prevents oxidation of the deposit 55 and cools a layer formed on the workpiece by injecting the shielding gas G. The beam nozzle 121, the wire nozzle 122, and the gas nozzle 123 are fixed to the machining head 12, and thereby the positional relationship thereamong is uniquely determined. That is, relative positions of the beam nozzle 121, the wire nozzle 122, and the gas nozzle 123 are fixed.

The laser oscillator 13 is a beam source that oscillates the laser beam L such as a solid laser, a gas laser, a fiber laser, or a semiconductor laser. The fiber cable 14 is an optical transmission path that propagates the laser beam L from the laser oscillator 13 to the beam nozzle 121 of the machining head 12. The fiber cable 14 connects the laser oscillator 13 and the machining head 12. The laser oscillator 13, the fiber cable 14, and the beam nozzle 121 of the machining head 12 constitute an irradiation unit that irradiates the workpiece with the laser beam L that melts the wire W.

The gas supply device 15 supplies the shielding gas G to the gas nozzle 123 through the pipe 16. The pipe 16 is connected between the gas supply device 15 and the gas nozzle 123 of the machining head 12, and serves as a flow path through which the shielding gas G flows from the gas supply device 15 to the gas nozzle 123. The gas supply device 15, the pipe 16, and the gas nozzle 123 of the machining head 12 constitute a gas supply unit that injects the shielding gas G to the machining point.

The wire spool 17 is a feed source of a material, specifically, the aluminum-based material, around which the wire W is wound. The rotary motor 18 rotates the wire spool 17 about a rotation axis. An example of the rotary motor 18 is a servomotor. When the wire spool 17 rotates with the driving of the rotary motor 18, the wire W is unwound from the wire spool 17. The wire W unwound from the wire spool 17 passes through the wire nozzle 122 and is fed to the machining point. The wire W fed to the machining point can be pulled out from the machining point by rotating the rotary motor 18 in a direction opposite to the direction when unwinding the wire W from the wire spool 17. In that case, a part of the wire W on a wire spool 17 side unwound from the wire spool 17 is wound around the wire spool 17. The wire spool 17, the rotary motor 18, and the wire nozzle 122 of the machining head 12 constitute a material feed unit that feeds a material to the workpiece.

Note that the wire nozzle 122 may be provided with an operation mechanism for pulling out the wire W from the wire spool 17. The additive manufacturing apparatus 100 can feed the wire W to the machining point by being provided with at least one of the rotary motor 18 or the operation mechanism of the wire nozzle 122. In FIG. 1, the operation mechanism of the wire nozzle 122 is not illustrated.

The head drive device 19 moves the machining head 12 in each of the X-axis direction, the Y-axis direction, and the Z-axis direction. The head drive device 19 includes a servomotor constituting an operation mechanism for moving the machining head 12 in the X-axis direction, a servomotor constituting an operation mechanism for moving the machining head 12 in the Y-axis direction, and a servomotor constituting an operation mechanism for moving the machining head 12 in the Z-axis direction. The head drive device 19 is an operation mechanism that enables translational movement in each direction of the three axes. In FIG. 1, the servomotors are not illustrated. The additive manufacturing apparatus 100 can move the irradiation position of the laser beam L on the workpiece by moving the machining head 12 by the head drive device 19. The additive manufacturing apparatus 100 may move the irradiation position of the laser beam L on the workpiece by moving the stage 11 or by moving both the head drive device 19 and the stage 11.

In the machining head 12 illustrated in FIG. 1, the laser beam L is emitted from the beam nozzle 121 in the Z-axis direction. The wire nozzle 122 is provided at a position away from the beam nozzle 121 in an XY plane, and advances the wire W in a direction oblique to the Z axis. Note that the wire nozzle 122 may advance the wire W in a direction parallel to the Z axis by being fixed in the Z axis direction in the machining head 12. The wire nozzle 122 limits the advancement of the wire W so that the wire W is fed to a desired position.

In the machining head 12 illustrated in FIG. 1, the gas nozzle 123 is provided coaxially with the beam nozzle 121 on an outer peripheral side of the beam nozzle 121 in the XY plane, and injects the shielding gas G along a central axis of the laser beam L emitted from the beam nozzle 121. That is, the beam nozzle 121 and the gas nozzle 123 are disposed coaxially with each other. Note that it is satisfactory as long as the shielding gas G is injected into a region including the machining point so that a material that melts and solidifies at the machining point irradiated with the laser beam L is not oxidized. Therefore, the gas nozzle 123 may inject the shielding gas G in a direction oblique to the Z axis. That is, the gas nozzle 123 may inject the shielding gas G in a direction oblique to the central axis of the laser beam L emitted from the beam nozzle 121.

The rotation mechanism 20 is an operation mechanism that enables rotation of the stage 11 about a first axis and rotation of the stage 11 about a second axis perpendicular to the first axis. In the rotation mechanism 20 illustrated in FIG. 1, the first axis is an axis parallel to the X axis, and the second axis is an axis parallel to the Y axis. The rotation mechanism 20 includes a servomotor constituting an operation mechanism for rotating the stage 11 about the first axis, and a servomotor constituting an operation mechanism for rotating the stage 11 about the second axis. The rotation mechanism 20 is an operation mechanism that enables rotational motion about each of the two axes. In FIG. 1, the servomotors are not illustrated.

The additive manufacturing apparatus 100 can change the posture or position of the workpiece by rotating the stage 11 by the rotation mechanism 20. That is, the additive manufacturing apparatus 100 can move the irradiation position of the laser beam L on the workpiece by rotating the stage 11. The additive manufacturing apparatus 100 can also make a complicated shape including a tapered shape by using the rotation mechanism 20.

The control device 21 controls the additive manufacturing apparatus 100 in accordance with a machining program. The control device 21 is a numerical control device in one example. The control device 21 controls the position of the head drive device 19 by outputting a position command to the head drive device 19. The control device 21 controls laser oscillation by the laser oscillator 13 by outputting, to the laser oscillator 13, an output command which is a command in accordance with a condition of beam intensity.

The control device 21 controls the rotary motor 18 by outputting, to the rotary motor 18, a feed command which is a command in accordance with a condition of a material feed amount. The feed command may be a command in accordance with a condition of a feed rate of the wire W. The feed rate is the rate of the wire W directing toward the irradiation position from the wire spool 17. The feed rate represents the material feed amount per hour.

The control device 21 controls the amount of the shielding gas G supplied from the gas supply device 15 to the gas nozzle 123 by outputting, to the gas supply device 15, a command in accordance with a condition of a gas supply amount. The control device 21 controls driving of the rotation mechanism 20 by outputting a rotation command to the rotation mechanism 20. That is, the control device 21 controls the entirety of the additive manufacturing apparatus 100 by outputting various commands. The control device 21 causes the additive manufacturing apparatus 100 to form a unit bead by controlling the material feed unit, the irradiation unit, the gas supply unit, the head drive device 19, and the rotation mechanism 20. The control device 21 corresponds to a control unit.

Next, a hardware configuration of the control device 21 will be described. Functions of the control device 21 are realized by a control program, which is a program for executing control of the additive manufacturing apparatus 100, being executed by using hardware.

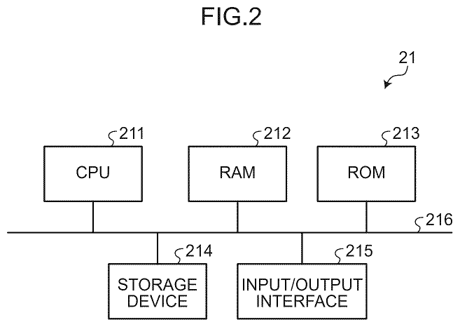

FIG. 2 is a block diagram illustrating an example of a hardware configuration of the control device included in the additive manufacturing apparatus according to the first embodiment. The control device 21 includes a central processing unit (CPU) 211 that executes various processes, a random access memory (RAM) 212 including a data storage area, a read only memory (ROM) 213 which is a nonvolatile memory, a storage device 214, and an input/output interface 215 for inputting information to the control device 21 and outputting information from the control device 21. The components illustrated in FIG. 2 are connected to each other via a bus 216.

The CPU 211 executes a program stored in the ROM 213 or the storage device 214. The control of the entirety of the additive manufacturing apparatus 100 by the control device 21 is realized by using the CPU 211.

The storage device 214 is a hard disk drive (HDD) or a solid state drive (SSD). The storage device 214 stores a control program and various data. In the ROM 213, a boot loader such as a basic input/output system (BIOS) unified extensible firmware interface (UEFI) as a program for basic control of a computer or a controller which is the control device 21, the boot loader being software or a program for controlling hardware, is stored. Note that the control program may be stored in the ROM 213.

The programs stored in the ROM 213 and the storage device 214 are loaded into the RAM 212. The CPU 211 develops the control program in the RAM 212 and executes various processes. The input/output interface 215 is a connection interface for connection with a device outside the control device 21. The input/output interface 215 receives an input of the machining program. In addition, the input/output interface 215 outputs various commands. The control device 21 may include input devices such as a keyboard and a pointing device, and an output device such as a display.

The control program may be stored in a computer-readable storage medium. The control device 21 may store the control program stored in the storage medium in the storage device 214. The storage medium may be a portable storage medium which is a flexible disk, or a flash memory which is a semiconductor memory. The control program may be installed on a computer or controller serving as the control device 21 from another computer or a server device via a communication network.

The functions of the control device 21 may be realized by a processing circuitry which is dedicated hardware for controlling the additive manufacturing apparatus 100. The processing circuitry is a single circuit, a composite circuit, a programmed processor, a parallel programmed processor, an application specific integrated circuit (ASIC), a field programmable gate array (FPGA), or a combination thereof. A part of the functions of the control device 21 may be realized by dedicated hardware and another part thereof may be realized by software or firmware.

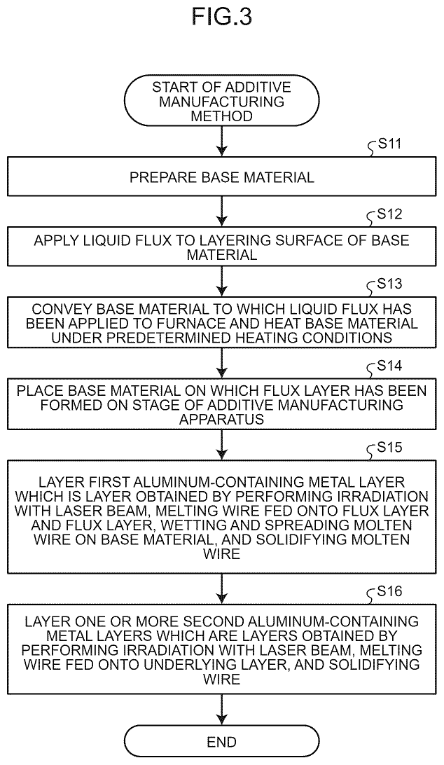

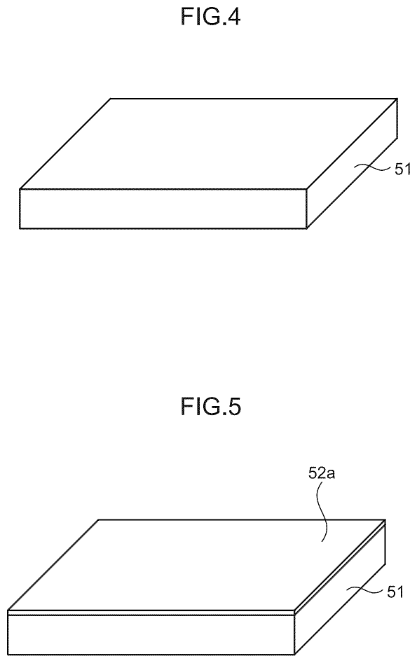

Next, an additive manufacturing method according to the first embodiment will be described. Since a three-dimensional additive manufactured object is manufactured by the additive manufacturing method, the additive manufacturing method described below is also a method for manufacturing an additive manufactured object. FIG. 3 is a flowchart illustrating an example of a procedure of the additive manufacturing method according to the first embodiment. FIGS. 4 to 8 are each a perspective view schematically illustrating an example of the procedure of the additive manufacturing method according to the first embodiment.

Here, as an example, a case will be described where the wire W made of the aluminum-based material is fed onto the base material 51 made of the iron-based material to manufacture a three-dimensional additive manufactured object by the additive manufacturing method. An example of the base material 51 is a plate material made of steel use stainless (SUS) 304 which is stainless steel. An example of the wire W is a wire made of A5183 defined in Japanese Industrial Standards (JIS) Z 3232. Note that A5183 corresponds to Al5183 defined by the International Organization for Standardization (ISO).

First, as illustrated in FIG. 4, the base material 51 made of the iron-based material is prepared (step S11). In the example in FIG. 4, the base material 51 is a plate-shaped member, but may not be a plate-shaped member. In one example, the base material 51 may be manufactured by the additive manufacturing apparatus 100 in which a wire made of the iron-based material is used as the wire W. Unlike the conventional technique, the zinc-based coating layer is not formed on the surface of the base material 51.

Next, as illustrated in FIG. 5, a liquid flux 52a is applied to a layering surface which is a part of the surface of the base material 51 (step S12). In one example, commercially available powdery flux and water are mixed at a weight ratio of 1:2 to form the liquid flux 52a. The liquid flux 52a is applied to the layering surface of the base material 51 by a method using a brush, a spray gun, or the like. In the application using the spray gun, the liquid flux 52a can be uniformly applied onto the base material 51. The layering surface is a surface on which a unit bead of the workpiece is formed. The step performed in step S12 corresponds to a first flux application step.

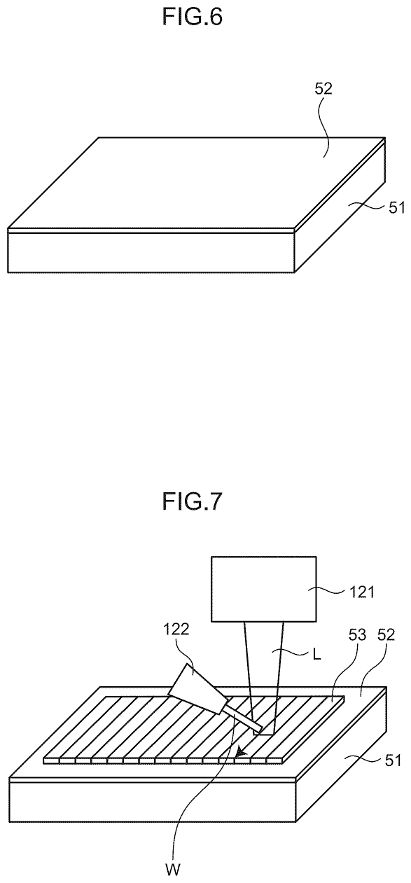

Thereafter, the base material 51 to which the liquid flux 52a has been applied is conveyed to a furnace, and the base material 51 is heated under predetermined heating conditions (step S13). Consequently, as illustrated in FIG. 6, the liquid flux 52a of the base material 51 is dried and solidified, and a flux layer 52 is formed on the layering surface of the base material 51. In one example, the base material 51 is heated under the following heating conditions: a heat treatment atmosphere is air, a heating temperature is 100 °C, and a heating time is 15 minutes. Thereafter, cooling of the base material 51 to room temperature is performed. The flux layer 52 corresponds to a first flux layer. The step performed in step S13 corresponds to a first flux solidification step.

The thickness of the flux layer 52 formed by heating is not particularly limited, but is preferably thick. In one example, the liquid flux 52a can be applied in step S12 so that the flux layer 52 having a desired thickness is obtained in step S13. In another example, the processes from step S12 to step S13 may be executed a plurality of times so that the flux layer 52 having a desired thickness is obtained. When the flux layer 52 is formed through the processes executed a plurality of times, the uniformity of the flux layer 52 can be enhanced.

Next, the base material 51 on which the flux layer 52 has been formed is placed on the stage 11 of the additive manufacturing apparatus 100 (step S14). Thereafter, a first aluminum-containing metal layer 53 is layered which is a layer obtained by performing irradiation with the laser beam L, melting the wire W fed onto the flux layer 52 and the flux layer 52, wetting and spreading the molten wire W on the base material 51, and solidifying the molten wire W, as illustrated in FIG. 7 by using the additive manufacturing apparatus 100 (step S15). That is, the first aluminum-containing metal layer 53 obtained by irradiating the wire W fed onto the flux layer 52 and the flux layer 52 with the laser beam L, melting the wire W and the flux layer 52, and solidifying the wire W and the flux layer 52, is layered. The laser beam L is supplied to a tip portion of the wire W. The first aluminum-containing metal layer 53 is constituted by a plurality of unit beads aligned in parallel. The wire W used here is a wire made of metal containing aluminum and not containing a flux. The wire W corresponds to a first wire. The process in step S15 corresponds to a first layering step.

The process performed by the additive manufacturing apparatus 100 in step S15 will be described in more detail. The base material 51 on which the flux layer 52 has been formed is placed and fixed on the stage 11 of the additive manufacturing apparatus 100. Thereafter, the control device 21 moves the machining head 12 to a position in accordance with the machining program, and controls the rotary motor 18 of the wire spool 17 so as to feed the wire W from the wire nozzle 122 to the machining point. In addition, the control device 21 controls the gas supply device 15 so as to inject the shielding gas G from the gas nozzle 123, and controls the laser oscillator 13 so as to emit the laser beam L from the beam nozzle 121. At that time, the control device 21 controls the output of the laser beam L so as to have a temperature lower than the melting point of the iron-based material and at which the flux is melted.

The flux layer 52 is melted by irradiation with the laser beam L. At that time, the base material 51 is not melted. The molten flux removes oxides and the like adhering to the surface of the base material 51. Consequently, the surface of the base material 51 becomes a clean surface, and is easily bonded to another material, that is, the aluminum-based material. In addition, the molten flux improves wettability of the molten wire W, that is, the molten aluminum-based material, and makes it easy to bond the underlying base material 51 and the aluminum-based material.

When the machining head 12 moves and the irradiation position of the laser beam L is shifted, the molten aluminum-based material at the irradiation position of the laser beam L before the shift solidifies on the base material 51 to be the first aluminum-containing metal layer 53. At that time, an intermetallic compound layer containing iron and aluminum and having a thickness of 2 μm or less is formed at an interface between the base material 51 and the first aluminum-containing metal layer 53. With this thin intermetallic compound layer, a strong bond between the base material 51 and the first aluminum-containing metal layer 53 is maintained.

The intermetallic compound layer cannot bond the base material 51 and the first aluminum-containing metal layer 53, when not present at the interface therebetween. Therefore, an intermetallic compound layer having a certain thickness is required. However, in a case where the thickness of the intermetallic compound layer is larger than about 2 μm, when an impact is applied to the additive manufactured object, the metal compound layer is cracked and peeled, and thus the joining between the base material 51 and the first aluminum-containing metal layer 53 is lost. Therefore, the thickness of the intermetallic compound layer is desirably 2 μm or less, and more desirably 1 μm or less.

If the wire W which is the aluminum-based material and the base material 51 which is the iron-based material are melted together by irradiation with the laser beam L without via the flux, an intermetallic compound layer having a thickness larger than 2 μm is formed at the interface. When the intermetallic compound layer having a thickness larger than 2 μm is present as described above, the joining at the interface between the base material 51 and the first aluminum-containing metal layer 53 is weakened. Therefore, in the first embodiment, the flux layer 52 having a melting point lower than the melting point of the iron-based material is formed on the base material 51. Consequently, by melting the flux without melting the iron-based material, the molten aluminum-based material can be wet and spread on the iron-based material. In addition, since the iron-based material is not melted, an excess reaction with the aluminum-based material is prevented, and a thin intermetallic compound layer having a thickness of 2 μm or less can be formed at the interface between the base material 51 and the first aluminum-containing metal layer 53.

By melting the flux layer 52 without melting the base material 51 and flowing the molten wire W into the molten flux layer 52 as described above, wettability of the molten wire W, that is, the molten aluminum-based material with respect to the base material 51 is improved. As a result, the base material 51 and the first aluminum-containing metal layer 53 are firmly joined. As illustrated in FIG. 7, since the wire W is not fed in a region not irradiated with the laser beam L, the flux layer 52 remains as it is.

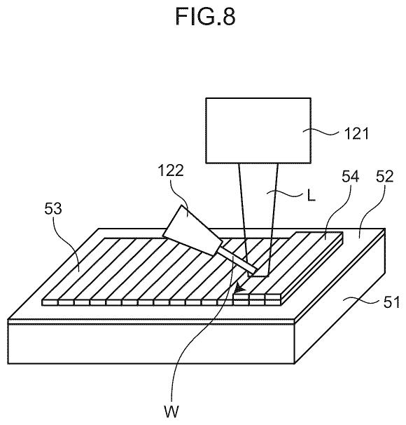

After the formation of the first aluminum-containing metal layer 53, as illustrated in FIG. 8, one or more second aluminum-containing metal layers 54 are layered which are layers obtained by performing irradiation with the laser beam L, melting the wire W fed onto an underlying layer, and solidifying the wire W (step S16). That is, one or more second aluminum-containing metal layers 54 obtained by irradiating the wire W fed onto the underlying layer with the laser beam L, melting the wire W, and solidifying the wire W, are layered on the underlying layer. In this example, the underlying layer is also irradiated with the laser beam L, the wire W and a part of the underlying layer are melted and solidified, and thus the second aluminum-containing metal layer 54 is layered. In step S16, the flux layer 52 is not formed on a layering surface of the first aluminum-containing metal layer 53 which is the underlying layer before the feeding of the wire W. The reason therefor is that since the underlying layer is not the base material 51 which is the iron-based material, even if the second aluminum-containing metal layer 54 is formed on the first aluminum-containing metal layer 53, the intermetallic compound layer that causes a problem is not formed. Therefore, in this example, a part of the underlying layer is melted by irradiation with the laser beam L and solidified together with the wire W. In a case where the second aluminum-containing metal layer 54 is formed on the first aluminum-containing metal layer 53, the underlying layer is the first aluminum-containing metal layer 53. In a case where the second aluminum-containing metal layer 54 is formed on the second aluminum-containing metal layer 54, the second aluminum-containing metal layer 54 that has been precedingly formed is the underlying layer. The wire W used in step S16 corresponds to a second wire, but is the same as the first wire in the first embodiment. Here, the wire W is a wire made of metal containing aluminum and not containing the flux. The process in step S16 corresponds to a second layering step.

Then, the formation of the second aluminum-containing metal layer 54 in step S16 is performed a predetermined number of times, and thereby the additive manufactured object is manufactured. This completes the additive manufacturing method.

In the first embodiment, after the liquid flux 52a is applied onto the base material 51 made of the iron-based material, the base material 51 is conveyed into the furnace, heated, and dried to thereby form the flux layer 52. Thereafter, the base material 51 is conveyed to the additive manufacturing apparatus 100, and while feeding the wire W made of the aluminum-based material onto the base material 51, a feeding position of the wire W is irradiated with the laser beam L whose output is adjusted so as to provide a temperature lower than the melting point of the base material 51 and higher than the melting point of the flux. Consequently, the base material 51 is not melted, the flux layer 52 is melted, and the molten wire W flows into the molten flux, and thereby the wire W, that is, the aluminum-based material wets and spreads on the base material 51. By changing the feeding position of the wire W and the irradiation position of the laser beam L, the aluminum-based material is solidified, and the first aluminum-containing metal layer 53 is formed on the base material 51. As a result, a strong bond is formed between the base material 51 and the first aluminum-containing metal layer 53. That is, the additive manufacturing method has an effect that even in a case of using materials that are very difficult to melt-bond, i.e., the aluminum-based material and the iron-based material, it is possible to realize stronger joining than before (prior art) at a joint portion of different materials of the iron-based material and the aluminum-based material.

### Second Embodiment

In the first embodiment, the liquid flux 52a is applied to the base material 51, the flux is heated and solidified in the furnace to form the flux layer 52, and then the base material 51 is conveyed to the additive manufacturing apparatus 100 to manufacture the three-dimensional additive manufactured object. Therefore, the base material 51 needs to be moved to a flux application device, the furnace, and the additive manufacturing apparatus 100, in this order. In a second embodiment, a description will be given for an additive manufacturing method capable of layering the aluminum-based material without melting the base material 51 made of the iron-based material only by the additive manufacturing apparatus 100.

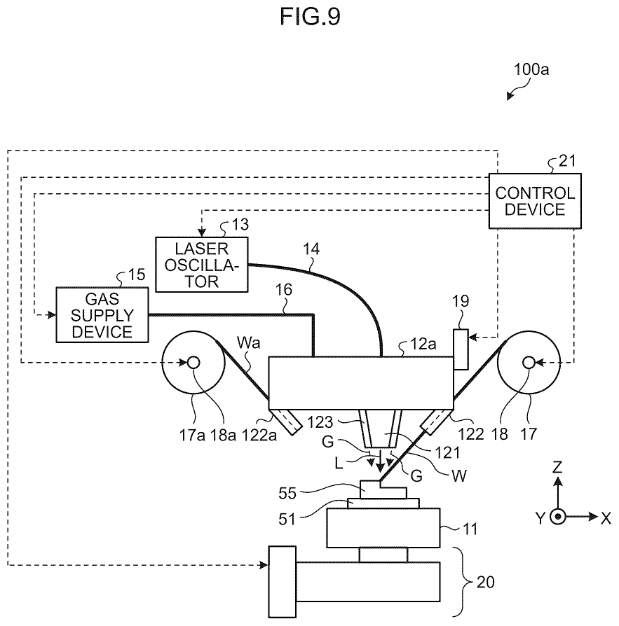

FIG. 9 is a diagram schematically illustrating an example of a configuration of an additive manufacturing apparatus according to the second embodiment. The same components as those in FIG. 1 will be denoted by the same reference numerals as those therein, descriptions thereof will be omitted, and differences from FIG. 1 will be described. An additive manufacturing apparatus 100a according to the second embodiment includes feed mechanisms for a plurality of wires W and Wa, which is a difference from the additive manufacturing apparatus 100 according to the first embodiment. That is, in the second embodiment, the additive manufacturing apparatus 100a includes a machining head 12a instead of the machining head 12, and further includes a wire spool 17a and a rotary motor 18a.

The machining head 12a further includes a wire nozzle 122a in addition to the beam nozzle 121, the wire nozzle 122, and the gas nozzle 123. The wire nozzle 122a advances the wire Wa toward the machining point. In a ZX plane passing through the center of the machining head 12a, the wire nozzle 122 is disposed in a positive X-axis direction of the beam nozzle 121, and the wire nozzle 122a is disposed in a negative X-axis direction of the beam nozzle 121. The wire nozzle 122a advances the wire Wa toward the irradiation position of the laser beam L on the workpiece similarly to the wire nozzle 122. The beam nozzle 121, the wire nozzle 122, the wire nozzle 122a, and the gas nozzle 123 are fixed to the machining head 12a, and thereby the positional relationship thereamong is uniquely determined. That is, relative positions of the beam nozzle 121, the gas nozzle 123, the wire nozzle 122, and the wire nozzle 122a are fixed.

The wire spool 17a is a feed source of a material different from the wire W, around which the wire Wa is wound. The rotary motor 18a rotates the wire spool 17a about a rotation axis. An example of the rotary motor 18a is a servomotor. When the wire spool 17a rotates with the driving of the rotary motor 18a, the wire Wa is unwound from the wire spool 17a. The wire Wa unwound from the wire spool 17a passes through the wire nozzle 122a and is fed to the irradiation position of the laser beam L, that is, the machining point. The wire Wa fed to the machining point can be pulled out from the irradiation position of the laser beam L by rotating the rotary motor 18a in a direction opposite to the direction when unwinding the wire Wa from the wire spool 17a. In that case, a part of the wire Wa on a wire spool 17a side unwound from the wire spool 17a is wound around the wire spool 17a. The rotary motor 188, the wire spool 17a, and the wire nozzle 122a constitute a first material feed unit that feeds a material to the workpiece, and the rotary motor 18, the wire spool 17, and the wire nozzle 122 constitute a second material feed unit that feeds a material to the workpiece.

Note that the wire nozzle 122a may be provided with an operation mechanism for pulling out the wire Wa from the wire spool 17a. The additive manufacturing apparatus 100a can feed the wire Wa to the machining point by being provided with at least one of the rotary motor 18a or the operation mechanism of the wire nozzle 122a. In FIG. 9, the operation mechanism of the wire nozzle 122a is not illustrated.

In the second embodiment, the wire W made of metal containing aluminum and not containing the flux is wound around the wire spool 17, and the wire made of metal containing aluminum and the flux, that is, a flux-cored wire Wa is wound around the wire spool 17a. Hereinafter, the wire Wa is also referred to as the flux-cored wire Wa. The flux-cored wire Wa corresponds to a flux-containing metal wire, and the wire W corresponds to a metal wire.

The wire W is fed from the wire nozzle 122, and the flux-cored wire Wa is fed from the wire nozzle 122a. In one example, the wire W is a wire made of a 5000-series aluminum alloy, and the flux-cored wire Wa is a wire in which the flux is included in the wire.

In a case where the first aluminum-containing metal layer 53 is formed on the base material 51, the control device 21 controls the first material feed unit so as to feed the flux-cored wire Wa to the base material 51 on the stage 11, and controls the irradiation unit so as to form the first aluminum-containing metal layer 53 obtained by melting the flux-cored wire Wa by irradiation with the laser beam L and solidifying the flux-cored wire Wa. Consequently, the first aluminum-containing metal layer 53 is formed on the base material 51. When the formation of the first aluminum-containing metal layer 53 is completed, the control device 21 winds the flux-cored wire Wa. In addition, the control device 21 controls the second material feed unit so as to feed the wire W onto the underlying layer, and controls the irradiation unit so as to form one or more second aluminum-containing metal layers 54 obtained by melting the wire W by irradiation with the laser beam L and solidifying the wire W. Consequently, the second aluminum-containing metal layer 54 is formed on the first aluminum-containing metal layer 53.

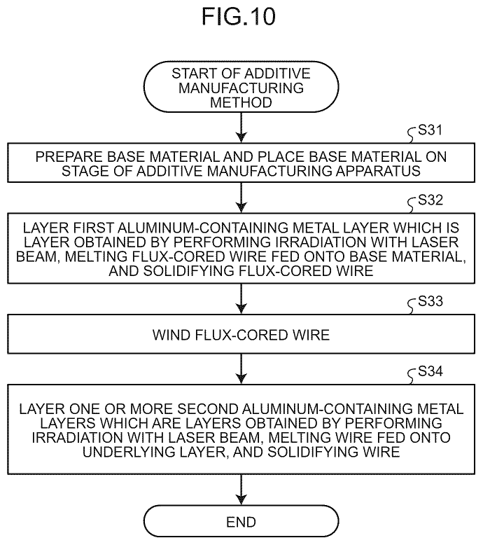

Next, an additive manufacturing method according to the second embodiment will be described. Since a three-dimensional additive manufactured object is manufactured by the additive manufacturing method, the additive manufacturing method described below is also a method for manufacturing an additive manufactured object. FIG. 10 is a flowchart illustrating an example of a procedure of the additive manufacturing method according to the second embodiment.

Here, as an example, a case will be described where the wire Wa in which the flux is included in the aluminum-based material and the wire W made of the aluminum-based material are fed onto the base material 51 made of the iron-based material to manufacture a three-dimensional additive manufactured object by the additive manufacturing method. An example of the base material 51 is a plate material made of SUS 304 which is stainless steel. An example of the wire W is a wire made of A5183 defined in JIS Z 3232. An example of the wire Wa is a flux-cored wire.

First, the base material 51 made of the iron-based material is prepared and placed on the stage 11 of the additive manufacturing apparatus 100a (step S31). The base material 51 may be a plate-shaped member, or may not be a plate-shaped member. In one example, the base material 51 may be manufactured by the additive manufacturing apparatus 100a in which a wire made of the iron-based material is used as the wire W.

Next, the first aluminum-containing metal layer 53 is layered which is a layer obtained by performing irradiation with the laser beam L, melting the flux-cored wire Wa fed onto the base material 51, and solidifying the flux-cored wire Wa (step S32). That is, the first aluminum-containing metal layer 53 obtained by irradiating the flux-cored wire Wa fed onto the base material 51 with the laser beam L, melting the flux-cored wire Wa, and solidifying the flux-cored wire Wa, is layered on the base material 51. As described above, in step S32, the control device 21 controls the rotary motor 18a of the wire spool 17a and the rotary motor 18 of the wire spool 17 so as to feed the flux-cored wire Wa from the wire nozzle 122a onto the base material 51 and not to feed the wire W from the wire nozzle 122. Note that the first aluminum-containing metal layer 53 may be a single layer, or a plurality thereof may be layered. In fourth and subsequent layers, even if irradiation with the laser beam L is performed using not the flux-cored wire Wa but the normal wire W under an irradiation condition of melting the first aluminum-containing metal layer 53 as a lower layer, heat due to the irradiation with the laser beam L is less likely to be transferred to the interface between the base material 51 and the first aluminum-containing metal layer 53 which is a first layer. Therefore, in one example, the first aluminum-containing metal layer 53 can be formed by layering layers of unit beads in a range of one layer to three layers. That is, in a case where the first aluminum-containing metal layer 53 is formed using the flux-cored wire Wa, it is desirable to form a layer of unit beads formed by melting and solidifying the flux-cored wire Wa in a range of one layer to three layers. The process in step S32 corresponds to the first layering step.

Also by melting and solidifying the flux-cored wire Wa on the base material 51, the molten flux-cored wire Wa wets and spreads on the base material 51, and the base material 51 and the first aluminum-containing metal layer 53 are firmly joined via the intermetallic compound layer having a thickness of 2 μm or less, similarly to the case of the first embodiment.

After the first aluminum-containing metal layer 53 is formed, the flux-cored wire Wa is wound (step S33). That is, the control device 21 controls the rotary motor 18a of the wire spool 17a so as to rotate in a direction opposite to a direction in which the flux-cored wire Wa is fed.

Thereafter, one or more second aluminum-containing metal layers 54 are layered which are layers obtained by performing irradiation with the laser beam L, melting the wire W fed onto the underlying layer, and solidifying the wire W (step S34). That is, one or more second aluminum-containing metal layers 54 obtained by irradiating the wire W fed onto the underlying layer and a part of the underlying layer with the laser beam L, melting the wire W and the part of the underlying layer, and solidifying the wire W and the part of the underlying layer, are layered. The process in step S34 corresponds to the second layering step.

Then, the formation of the second aluminum-containing metal layer 54 in step S34 is performed a predetermined number of times, and thereby the additive manufactured object is manufactured. This completes the additive manufacturing method.

Note that in a case where the amount of the flux of the flux-cored wire Wa is insufficient in step S31, combination with the first embodiment may be performed. In that case, it is sufficient that in step S31, the base material 51 on which the liquid flux 52a has been applied and dried to form the flux layer 52 is placed on the stage 11 of the additive manufacturing apparatus 100a, and the procedure illustrated in FIG. 10 is executed. Since the flux layer 52 is formed on the base material 51 in that case, even when the amount of flux contained in the flux-cored wire Wa is insufficient, a sufficient amount of the molten flux can be formed on the base material 51, and the aluminum-based material can be wet and spread on the base material 51.

In addition, in one example, it may be difficult to procure the flux-cored wire Wa having a desired composition. In such a case, the first aluminum-containing metal layer 53 made of an aluminum-based material having a composition different from a composition of the second aluminum-containing metal layer 54 may be formed. In one example, the flux-cored wire Wa made of an aluminum-based material having a composition different from a composition of the wire W wound around the wire spool 17 is wound around the wire spool 17a. In one example, in a case where the wire W is a 5000-series aluminum-based wire such as A 5183, a flux-cored wire referred to as 4000-series such as A4043 or A4047 defined in JIS Z 3232 can be used as the flux-cored wire Wa. In a case where such a 4000-series flux-cored wire is used as the flux-cored wire Wa, a ternary intermetallic compound layer of aluminum-silicon-iron containing silicon is generated at the interface between the base material 51 and the first aluminum-containing metal layer 53.

In that case, in step S32, the first aluminum-containing metal layer 53 obtained by aligning the unit beads in parallel and layering the unit beads in a range of one layer to three layers by using the flux-cored wire Wa, is formed. In step S34, the second aluminum-containing metal layer 54 is formed by using the wire W. Since the first aluminum-containing metal layer 53 is in the range of one layer to three layers, the thickness thereof is very small as compared with the entire thickness of the second aluminum-containing metal layer 54, and therefore even if there is a slight difference in composition, the influence thereof on the additive manufactured object is small.

In the second embodiment, the flux-cored wire Wa in which the flux is included in the aluminum-based metal is fed onto the base material 51 made of the iron-based material, and the flux-cored wire Wa is melted by the laser beam L and solidified to form the first aluminum-containing metal layer 53. Thereafter, the wire W made of the aluminum-based material is fed onto the first aluminum-containing metal layer 53, and the wire W and the first aluminum-containing metal layer 53 as a lower layer are melted by the laser beam L and solidified to form the second aluminum-containing metal layer 54. Also through the above processes, similarly to the first embodiment, the additive manufacturing method has an effect that even in a case of using materials that are very difficult to melt-bond, i.e., the aluminum-based material and the iron-based material, it is possible to realize stronger joining than before (prior art) at a joint portion of different materials of the iron-based material and the aluminum-based material.

In addition, in the second embodiment, it is possible to skip the step of applying the liquid flux 52a onto the base material 51, and performing heating in the furnace to dry and solidify the liquid flux 52a. As a result, there is also an effect that a time required for manufacturing the additive manufactured object can be shortened as compared with the first embodiment.

### Third Embodiment

In the first and second embodiments, after the first aluminum-containing metal layer 53 is formed on the base material 51, the wire W made of the aluminum-based material is fed, melted, and solidified to form the second aluminum-containing metal layer 54. In a case where the aluminum-containing metal layer is layered on the aluminum-containing metal layer, there is no need to care about the formation of the intermetallic compound layer. However, in a case where the aluminum-containing metal layer is formed on the aluminum-containing metal layer, the aluminum-containing metal layer as a lower layer also needs to be melted, so that the output of the laser beam L needs to be increased. In a case where the output of the laser beam L is large, heat is transferred to the first aluminum-containing metal layer 53 as the first layer on the base material 51. Then, the heat causes a thin intermetallic compound layer formed between the base material 51 and the first aluminum-containing metal layer 53 to grow and increase in thickness. When the intermetallic compound layer increases in thickness, the intermetallic compound layer is easily broken by an impact applied to the additive manufactured object, and the joining between the base material 51 and the first aluminum-containing metal layer 53 is lost. Therefore, an additive manufacturing method capable of reducing the output of the laser beam L at the time of forming the second aluminum-containing metal layer 54 will be described.

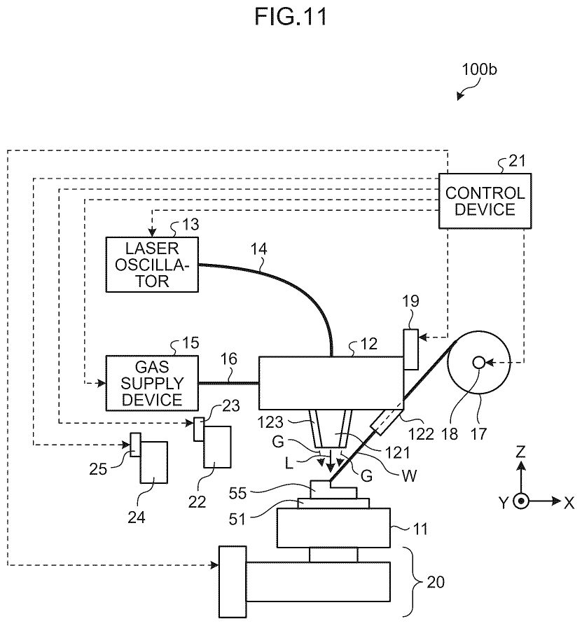

FIG. 11 is a diagram schematically illustrating an example of a configuration of an additive manufacturing apparatus according to a third embodiment. The same components as those in FIG. 1 will be denoted by the same reference numerals as those therein, descriptions thereof will be omitted, and differences from FIG. 1 will be described. An additive manufacturing apparatus 100b according to the third embodiment further includes a flux application device 22, an application drive device 23, a flux solidification device 24, and a solidification drive device 25.

The flux application device 22 applies the liquid flux 52a to the layering surface of the workpiece placed on the stage 11. In one example, the flux application device 22 drops or injects the liquid flux 52a onto the layering surface of the workpiece. The workpiece is the base material 51, the base material 51 on which the first aluminum-containing metal layer 53 is formed, or the base material 51 on which the second aluminum-containing metal layer 54 and the first aluminum-containing metal layer 53 are formed.

The application drive device 23 moves the flux application device 22 in each of the X-axis direction, the Y-axis direction, and the Z-axis direction. The application drive device 23 includes a servomotor constituting an operation mechanism for moving the flux application device 22 in the X-axis direction, a servomotor constituting an operation mechanism for moving the flux application device 22 in the Y-axis direction, and a servomotor constituting an operation mechanism for moving the flux application device 22 in the Z-axis direction. The application drive device 23 is an operation mechanism that enables translational movement in each direction of the three axes. In FIG. 11, the servomotors are not illustrated. The additive manufacturing apparatus 100b can move an application position of the liquid flux 528 on the workpiece by moving the flux application device 22 by the application drive device 23. The additive manufacturing apparatus 100b may move the application position of the liquid flux 52a on the workpiece by moving the stage 11 or by moving both the flux application device 22 and the stage 11. The flux application device 22 and the application drive device 23 constitute a flux application unit that applies the liquid flux 52a.

The flux solidification device 24 is a device that solidifies the liquid flux 52a by applying hot air to the liquid flux 52a applied on the layering surface of the workpiece. An example of the flux solidification device 24 is a dryer that heats air and blows the air out onto the layering surface of the workpiece. In another example, the flux solidification device 24 may be a device that solidifies the liquid flux 52a by disposing an object having a temperature higher than or equal to a solidification temperature of the liquid flux 52a close to the liquid flux 52a.

The solidification drive device 25 moves the flux solidification device 24 in each of the X-axis direction, the Y-axis direction, and the Z-axis direction. The solidification drive device 25 includes a servomotor constituting an operation mechanism for moving the flux solidification device 24 in the X-axis direction, a Servomotor constituting an operation mechanism for moving the flux solidification device 24 in the Y-axis direction, and a servomotor constituting an operation mechanism for moving the flux solidification device 24 in the Z-axis direction. The solidification drive device 25 is an operation mechanism that enables translational movement in each direction of the three axes. In FIG. 11, the Servomotors are not illustrated. The additive manufacturing apparatus 100b can move a heating position of the flux on the workpiece by moving the flux solidification device 24 by the solidification drive device 25. The additive manufacturing apparatus 100b may move the heating position of the flux on the workpiece by moving the stage 11 or by moving both the flux solidification device 24 and the stage 11. The flux solidification device 24 and the solidification drive device 25 constitute a heating unit that dries the liquid flux 52a.

In a case of forming the second aluminum-containing metal layer 54, the control device 21 controls an operation of the flux application unit so as to apply the liquid flux 52a onto the layering surface which is a part of the surface of the underlying layer. In addition, the control device 21 controls an operation of the heating unit so as to heat the liquid flux 52a applied to the layering surface to form the flux layer 52 which is a layer of the liquid flux 52a that has been solidified. In this example, after the completion of the application of the liquid flux 52a by the flux application device 22, hot air from the flux solidification device 24 is blown out to the liquid flux 52a. The underlying layer is a lower layer in which a unit bead is formed, and is the deposit 55 formed immediately before a new deposit 55 is formed. The flux layer 52 formed when the second aluminum-containing metal layer 54 is formed corresponds to a second flux layer.

Here, the case where the flux solidification device 24 is a dryer has been described as an example, but the liquid flux 52a that has been applied may be irradiated with the laser beam L, and thereby the liquid flux 52a may be solidified. In that case, the flux solidification device 24 and the solidification drive device 25 are substituted by the beam nozzle 121 and the head drive device 19. The control device 21 performs control so that the region applied with the liquid flux 52a is irradiated with the laser beam L while being scanned, the laser beam L having an output that allows the liquid flux 52a to dry.

The liquid flux 52a may be applied onto the base material 51 by the flux application device 22, and the liquid flux 52a may be solidified by the flux solidification device 24 to form the flux layer 52, also when the first aluminum-containing metal layer 53 is formed on the base material 51. In that case, the control device 21 controls the flux application unit so as to apply the liquid flux 52a to the layering surface which is a part of the surface of the base material 51 on the stage 11. The control device 21 controls the heating unit so as to heat the liquid flux 52a applied onto the base material 51 to form the flux layer 52. The control device 21 controls the material feed unit so as to feed the wire W onto the flux layer 52, and controls the irradiation unit so as to form the first aluminum-containing metal layer 53 obtained by melting the wire W and the flux layer 52 without melting the base material 51 by irradiation with the laser beam L and solidifying the wire W and the flux layer 52. The control device 21 controls the flux application unit so as to apply the liquid flux 52a onto the layering surface which is a part of the surface of the underlying layer, after the formation of the first aluminum-containing metal layer 53. The control device 21 controls the heating unit so as to form the flux layer 52 which is a layer obtained by heating and drying the liquid flux 52a applied to the layering surface. The control device 21 controls the material feed unit so as to feed the wire W onto the flux layer 52, and controls the irradiation unit so as to form the second aluminum-containing metal layer 54 obtained by melting the wire W and the flux layer 52 by irradiation with the laser beam L and solidifying the wire W and the flux layer 52. Consequently, it is no longer necessary to form the flux layer 52 by applying and drying the liquid flux 52a at a location different from the additive manufacturing apparatus 100 as in the first embodiment, and the additive manufacturing apparatus 100b can perform these processes.

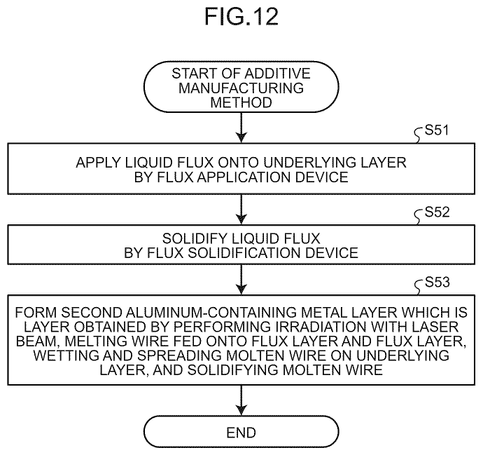

Next, an additive manufacturing method according to the third embodiment will be described. Since a three-dimensional additive manufactured object is manufactured by the additive manufacturing method, the additive manufacturing method described below is also a method for manufacturing an additive manufactured object. FIG. 12 is a flowchart illustrating an example of a procedure of the additive manufacturing method according to the third embodiment. Here, details of the process of forming the second aluminum-containing metal layer 54 in step S16 of FIG. 3 of the first embodiment or step S34 of FIG. 10 of the second embodiment are illustrated. That is, the additive manufacturing method from the state in which the first aluminum-containing metal layer 53 is formed will be described.

First, the flux application device 22 applies the liquid flux 52a onto the layering surface which is a part of the surface of the underlying layer (step S51). That is, the control device 21 controls the flux application unit so as to apply the liquid flux 52a onto the underlying layer. In a case where the second aluminum-containing metal layer 54 is first formed, the underlying layer is the first aluminum-containing metal layer 53. The process in step S51 corresponds to a second flux application step.

After the application of the liquid flux 52a is completed, the flux solidification device 24 forms the flux layer 52 obtained by solidifying the liquid flux 52a applied to the layering surface (step S52). The liquid flux 52a is solidified by heating and drying. In the example in FIG. 11, the flux solidification device 24 blows hot air to the liquid flux 52a on the first aluminum-containing metal layer 53. That is, the control device 21 controls the heating unit so as to apply the hot air from the flux solidification device 24 to the liquid flux 52a that has been applied. Consequently, the flux layer 52 obtained by solidifying the liquid flux 52a is formed. The flux layer 52 formed in step S52 corresponds to the second flux layer. The step S52 corresponds to a second flux solidification step.

Thereafter, the second aluminum-containing metal layer 54 is formed which is a layer obtained by performing irradiation with the laser beam L, melting the wire W fed onto the flux layer 52 and the flux layer 52, wetting and spreading the molten wire W on the underlying layer, and solidifying the molten wire W (step S53). That is, the second aluminum-containing metal layer 54 obtained by irradiating the wire W fed onto the flux layer 52 and the flux layer 52 with the laser beam L, melting the wire W and the flux layer 52, and solidifying the wire W and the flux layer 52, is formed. At that time, the output of the laser beam L is adjusted so that the first aluminum-containing metal layer 53 as the underlying layer is not melted, and the flux layer 52 is melted. Consequently, the molten aluminum-based material is poured into the molten flux. The molten aluminum-based material wets and spreads on the underlying layer along the molten flux. Then, the irradiation position of the laser beam L is shifted, and thereby the wet and spread aluminum-based material is solidified to form the second aluminum-containing metal layer 54.

As described above, since it is not necessary to melt the first aluminum-containing metal layer 53 as the underlying layer and it is only necessary to melt the flux layer 52 having a melting point lower than the first aluminum-containing metal layer 53, the output of the laser beam L can be reduced as compared with the cases of the first and second embodiments.

The above processes in step S51 to step S53 are repeatedly executed until the number of second aluminum-containing metal layers 54 reaches a desired number thereof to manufacture the additive manufactured object. In a case where the second aluminum-containing metal layer 54 as any of second and subsequent layers is formed, the underlying layer is the second aluminum-containing metal layer 54 that has been precedingly formed. After the additive manufactured object is manufactured, the process is completed.

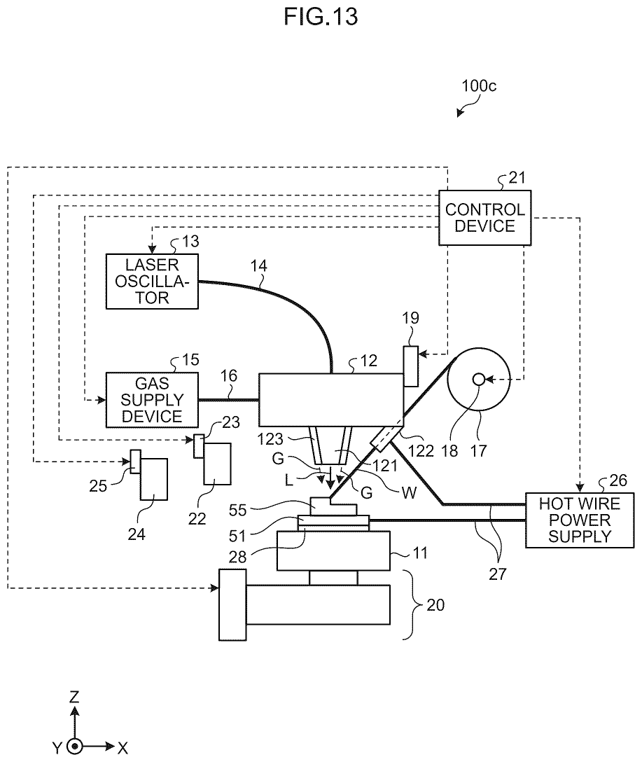

Another method for reducing the output of the laser beam L in a case where the second aluminum-containing metal layer 54 is formed on the first aluminum-containing metal layer 53 will be described. FIG. 13 is a diagram schematically illustrating another example of a configuration of an additive manufacturing apparatus according to the third embodiment. The same components as those in FIGS. 1 and 11 will be denoted by the same reference numerals as those therein, descriptions thereof will be omitted, and differences from FIGS. 1 and 11 will be described. An additive manufacturing apparatus 100c further includes a hot wire power supply 26, current cables 27, and an insulating member 28, in addition to the configuration of FIG. 11.

The hot wire power supply 26 is a power supply that generates a high current for heating the metal wire W to around the melting point. The hot wire power supply 26 applies a current between the wire W and the base material 51. One of the current cables 27 connects the hot wire power supply 26 and the wire nozzle 122. Another one of the current cables 27 connects the hot wire power supply 26 and the base material 51. When the current from the hot wire power supply 26 flows to the wire nozzle 122 through the current cable 27, the current flows to the wire W in contact with the wire nozzle 122. Consequently, the wire W is heated. The insulating member 28 insulates the stage 11 and the base material 51. During a manufacturing process, a current flows between the wire nozzle 122 and the base material 51, and the insulating member 28 is provided in order to prevent the current from flowing to a member below the stage 11.

Since there is electric resistance in the wire W, Joule heat is generated in the wire W by a current flowing through the wire W. The temperature of the wire W is increased by Joule heat. That is, the current is applied to the wire W to heat the wire W. In the case of FIG. 13, the laser beam L with which the wire W is irradiated and Joule heat generated in the wire W serve as a heat source for melting the wire W. In the additive manufacturing apparatus 100c, Joule heat in addition to the heating by the laser beam L promotes the melting of the wire W, and can improve a machining speed. In order to improve the machining speed, it is desirable to heat the wire W to the vicinity of the melting point of the wire W by Joule heat. In addition, since Joule heat is applied to the wire W, the output of the laser beam L for melting the wire W can be limited. As a result, excessive heat input to the workpiece due to irradiation with the laser beam L is prevented.

Furthermore, in a case where the wire W is fed onto the workpiece, a tip of the wire W comes into contact with the workpiece. In a case where the flux layer 52 is formed, when the wire W is fed while the tip of the wire W is in contact with the flux layer 52, the hard wire W scratches the flux layer 52. As a result, the flux layer 52 may be peeled off. However, when a current is applied to the wire W, the wire W is softened by Joule heat. As result, even in a case where the wire W is fed while the tip of the wire W is in contact with the flux layer 52, the wire W is prevented from scratching the flux layer 52, and peeling of the flux layer 52 is prevented.

The control device 21 controls the hot wire power supply 26 so that a current flows between the wire W and the stage 11 when the wire W is fed onto the flux layer 52.

In FIG. 13, a configuration is employed in which the additive manufacturing apparatus 100b in FIG. 11 is provided with the hot wire power supply 26, the current cables 27, and the insulating member 28. However, configuration may be employed in which the additive manufacturing apparatus 100 or 100a in FIG. 1 or FIG. 9 is provided with the hot wire power supply 26, the current cables 27, and the insulating member 28.

In the third embodiment, the additive manufacturing apparatuses 100b and 100c each further include the flux application device 22 that applies the liquid flux 52a, the application drive device 23 that drives the flux application device 22, the flux solidification device 24 that solidifies the liquid flux 52a that has been applied, and the solidification drive device 25 that drives the flux solidification device 24. Consequently, it is no longer necessary to move the base material 51 for applying the liquid flux 52a when the second aluminum-containing metal layer 54 is formed. That is, the flux can be applied by the additive manufacturing apparatuses 100b and 100c without moving the base material 51, and the applied flux can be dried. As a result, there is no need to melt the aluminum-containing metal layer as the underlying layer when the second aluminum-containing metal layer 54 is formed, so that the output of the laser beam L can be reduced. Since the output of the laser beam L can be reduced, it is possible to reduce heat due to the irradiation of the laser beam L to be transferred to the first aluminum-containing metal layer 53 as the first layer on the base material 51. Since heat is less likely to be transferred to the first aluminum-containing metal layer 53, the growth of the intermetallic compound layer at the interface between the base material 51 and the first aluminum-containing metal layer 53 is reduced. Consequently, even in a case where an impact is applied to the additive manufactured object, it is possible to prevent the joining between the base material 51 and the first aluminum-containing metal layer 53 from being lost due to cracking of the intermetallic compound layer.

In a case where the base material 51 is removed from the stage 11 of each of the additive manufacturing apparatuses 100b and 100c for forming the flux layer 52 each time the second aluminum-containing metal layer 54 is formed, positional misalignment occurs when the base material 51 is placed on the stage 11 again. As a result misalignment occurs also at a position where the second aluminum-containing metal layer 54 is formed, which makes it difficult to manufacture an additive manufactured object having a desired shape. However, in the third embodiment, when the second aluminum-containing metal layer 54 is formed, it is not necessary to remove the base material 51 once placed on the stage 11 of each of the additive manufacturing apparatuses 100b and 100c for forming the flux layer 52. Since the base material 51 is not placed again, there is an effect that an additive manufactured object having a desired shape can be manufactured without positional misalignment.

Furthermore, in the third embodiment, a current is applied to the wire W to heat the wire W. Consequently, the wire W can be melted while reducing the output of the laser beam L. In addition, the wire W is softened by Joule heat due to the current flowing through the wire W, and thus it is possible to prevent the tip of the wire W from causing damage to the flux layer 52, or to prevent peeling of the flux layer 52.

### Fourth Embodiment

In the third embodiment, the example has been described in which when the second aluminum-containing metal layer 54 is formed, the output of the laser beam L is limited by applying the liquid flux 52a to the layering surface or by applying the current to the wire W to be fed. In a fourth embodiment, a case will be described where the energy density of the laser beam L is reduced by increasing a beam diameter.

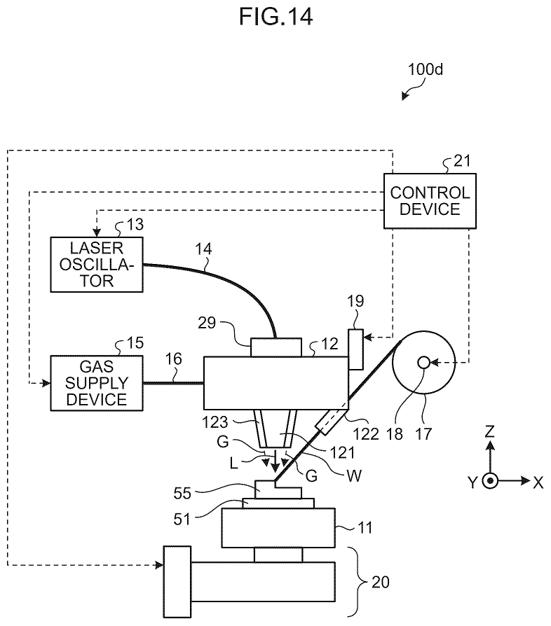

FIG. 14 is a diagram schematically illustrating an example of a configuration of an additive manufacturing apparatus according to the fourth embodiment. The same components as those in FIG. 1 will be denoted by the same reference numerals as those therein, descriptions thereof will be omitted, and differences from FIG. 1 will be described. An additive manufacturing apparatus 100d according to the fourth embodiment further includes a shaping optical system 29 between the fiber cable 14 and the beam nozzle 121 of the machining head 12. The shaping optical system 29 is an element that shapes the profile of the laser beam L output from the fiber cable 14. In one example, the shaping optical system 29 increases the beam diameter of the laser beam L and homogenizes the intensity distribution of the laser beam L. The laser beam L output from the shaping optical system 29 is incident on the beam nozzle 121. In the fourth embodiment, the laser beam L is used which is shaped to have a homogeneous intensity distribution by increasing the beam diameter of the laser beam L output from the fiber cable 14.

As the shaping optical system 29, a fly-eye lens, an aspherical lens, a diffractive optical element (DOE), a kaleidoscope, a multifaceted prism, or the like can be used. A scanner such as a galvanometer mirror can also be used as the shaping optical system 29.

The fly-eye lens is an optical element in which lenses are aligned in an array like a fly's eye. A beam profile having a homogeneous intensity distribution can be formed by the fly-eye lens. In addition, a rectangular beam profile can be formed by the fly-eye lens.

The aspherical lens, of which a peripheral portion and a central portion have different shapes, is an optical element that forms a beam profile having a homogeneous intensity distribution by using a difference in condensing characteristics of the laser beams L having passed through regions of the peripheral portion and the central portion. The aspherical lens is used when forming a circular uniform beam, in one example.

The diffractive optical element is an optical element that intentionally causes a diffraction phenomenon by forming irregularities of wavelength order on a surface of an optical substrate to form a beam profile having a homogeneous intensity distribution in a circular shape, a rectangular shape, or a linear shape.

The kaleidoscope is an optical element that forms a rectangular beam profile having a homogeneous intensity distribution by combining four mirrors into a rectangle with mirror surfaces facing inward, in one example.

The multifaceted prism is an optical element that forms a beam profile having a desired shape and a homogeneous intensity distribution by a difference in a refraction angle of a beam on an exit surface with respect to incident light.

An example of the diameter of the wire W is 1.2 mm. The beam diameter, which is the diameter of the laser beam L when the shaping optical system 29 is not used, is about 3 mm which is larger than the diameter of the wire W. In the fourth embodiment, the beam diameter is increased to be larger than 3 mm by the shaping optical system 29. In one example, the beam diameter is 10 mm, and furthermore, can be 10 mm or more. When the beam diameter is increased, an irradiation region of the laser beam L is increased, and more wire W can be fed to the irradiation region. In order to feed more wire W to the irradiation region of the laser beam L, there are a method in which the feed rate of the wire W is increased, a method in which a plurality of wires W are introduced, a method in which the diameter of the wire W is increased, and the like. The method in which the feed rate of the wire W is increased is realized by increasing the rotational speed of the rotary motor 18 of the wire spool 17 by the control device 21. The method in which a plurality of wires W are introduced is realized by the machining head 12 including a plurality of wire nozzles 122 and 122a and simultaneously feeding the same type of wires W and Wa from the plurality of wire nozzles 122 and 122a as in FIG. 9 of the second embodiment. The method in which the diameter of the wire W is increased is realized by making the thickness of the wire W to be wound around the wire spool 17 larger than the thickness of the wire W used when the shaping optical system 29 is not used.

Note that, in a case where the beam diameter is increased while the laser beam 1 remains circular, irradiation with the laser beam L is performed on a portion of the underlying layer not desired to be irradiated. Therefore, it is desirable that the circular laser beam L be shaped into the rectangular laser beam L by the shaping optical system 29 to irradiate, with the laser beam L, only a portion desired to be irradiated. By causing the laser beam L to have a rectangular beam profile as described above, a portion desired to be irradiated, that is, a portion desired to be melted is irradiated with the laser beam L, and energy efficiency can be improved as compared with a case of a circular beam profile.

In the configuration of the fourth embodiment, a mechanism for heating the wire W described in FIG. 13 of the third embodiment may be combined. In a case where an area irradiated with the laser beam L is larger than an irradiated area of the wire W, the output of the laser beam L per unit area decreases, and thus a method in which the wire W is fed onto the workpiece while being heated is effective for melting the wire W.

As the laser oscillator 13, a gas laser, a solid laser, a fiber laser, a semiconductor laser, or the like can be used. However, when the beam diameter is increased by the shaping optical system 29, it is desirable to use a semiconductor laser that outputs the laser beam L having a larger beam diameter than the gas laser, the solid laser, and the fiber laser.

In the fourth embodiment, the additive manufacturing apparatus 100d includes the shaping optical system 29 that increases the beam diameter of the laser beam L oscillated from the laser oscillator 13 to uniformize intensity. Consequently, the additive manufacturing apparatus 100d can irradiate a wider range, and can feed more wire W to the irradiation region. As a result, there is an effect that unit beads in a wide range can be formed at once, and thus a manufacturing speed can be increased. In addition, since the energy density of the laser beam L is reduced by increasing the irradiation region of the laser beam L, heat is less likely to be transferred to the first aluminum-containing metal layer 53 in contact with the base material 51 even in a case of using the laser beam L having the same output as in a case where the shaping optical system 29 is not used.

Consequently, the growth of the intermetallic compound layer at the interface between the base material 51 and the first aluminum-containing metal layer 53 is reduced, and a three-dimensional additive manufactured object having strong joining can be obtained.

### Fifth Embodiment

When the unit bead is continuously manufactured by irradiating the wire W with the laser beam L, melting the wire W, and solidifying the wire W, in one example, in the manufacture of one layer, heat is stored in a portion manufactured last as compared with a portion manufactured first. Therefore, a temperature rises, resulting in excessive heat input at a portion manufactured last in a manufacturing process of a certain layer. In a case where excessive heat input occurs, heat may be transferred to the first aluminum-containing metal layer 53 as the first layer in contact with the base material 51. In that case, as described above, the intermetallic compound layer at the interface between the base material 51 and the first aluminum-containing metal layer 53 grows. In addition, a portion of the underlying layer that is not melted and a portion thereof that is melted are generated, and thus machining quality may be deteriorated. Therefore, in a fifth embodiment, a case will be described where excessive heat input is prevented.

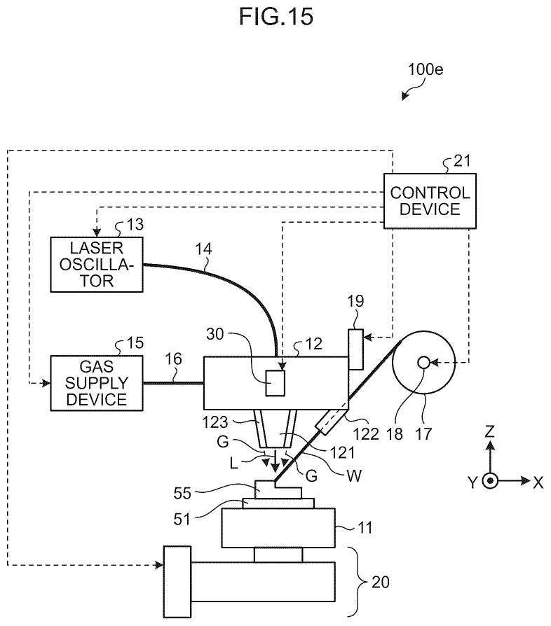

FIG. 15 is a diagram schematically illustrating an example of a configuration of an additive manufacturing apparatus according to the fifth embodiment. The same components as those in FIG. 1 will be denoted by the same reference numerals as those therein, descriptions thereof will be omitted, and differences from FIG. 1 will be described. An additive manufacturing apparatus 100e according to the fifth embodiment further includes a temperature measurement unit 30 that measures a temperature of a machining point which is an irradiation position of the laser beam L on the workpiece. An example of the temperature measurement unit 30 is an infrared thermometer that measures the intensity of infrared rays emitted from the machining point. The infrared thermometer may be attached inside the machining head 12 or may be attached outside the machining head 12. In the case where the infrared thermometer is attached inside the machining head 12, it is desirable to attach the infrared thermometer so as to have the same axis as the output of the laser beam L. Consequently, a temperature from directly above the machining point can be measured, and thus a more accurate temperature can be measured. The temperature measurement unit 30 outputs a temperature measurement value which is a measurement result of the temperature of the machining point to the control device 21.

The control device 21 acquires the temperature measurement value of the machining point from the temperature measurement unit 30, and controls the laser oscillator 13 so as to reduce the output of the laser beam L in a case where the acquired temperature measurement value is higher than a predetermined reference value. The predetermined reference value can be a temperature at which the flux layer 52, the first aluminum-containing metal layer 53, or the second aluminum-containing metal layer 54 is melted. In a case where the first aluminum-containing metal layer 53 is formed on the base material 51 on which the flux layer 52 has been formed, first, the laser beam L is output so that the machining point becomes the predetermined reference value which is a temperature lower than the melting point of the base material 51 and higher than or equal to the melting point of the flux layer 52. However, if the irradiation with the laser beam L having the same output is continued, heat accumulates in the workpiece due to the irradiation with the laser beam L as machining is continued, and the temperature of the machining point exceeds the predetermined reference value. In such a case, the control device 21 controls the irradiation unit, that is, the laser oscillator 13 so as to reduce the output of the laser beam L so that the temperature of the machining point becomes the predetermined reference value.

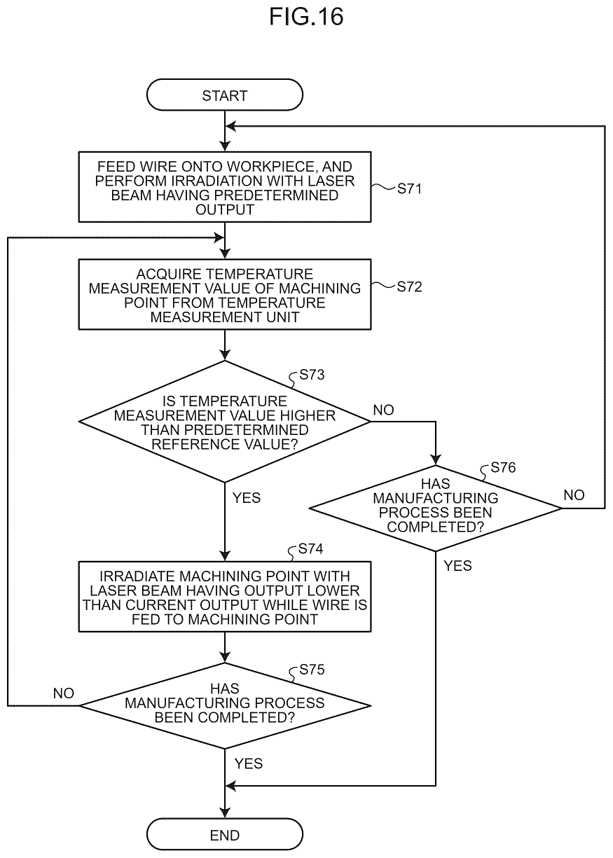

FIG. 16 is a flowchart illustrating an example of a procedure of an additive manufacturing method according to the fifth embodiment. Here, a process of controlling the temperature of the machining point at the time of forming the first aluminum-containing metal layer 53 or the second aluminum-containing metal layer 54 is illustrated. Hereinafter, the first aluminum-containing metal layer 53 and the second aluminum-containing metal layer 54 are referred to as aluminum-containing metal layers when no distinction is made therebetween.

First, the wire W is fed onto the workpiece, and irradiation with the laser beam L having a predetermined output is performed (step S71). That is, the control device 21 controls the material feed unit so as to feed the wire W to the machining point, and controls the irradiation unit so as to irradiate the machining point including the tip of the wire W with the laser beam L having the predetermined output. At the start of machining, the predetermined output is a preset output of the laser beam L. In a case where the output of the laser beam L is reduced in step S74 described later, the predetermined output is the output of the laser beam L determined in step S74 which is most recent.

The temperature measurement unit 30 always measures the temperature of the machining point during the manufacturing process. The control device 21 acquires a temperature measurement value which is a measurement value of the temperature of the machining point from the temperature measurement unit 30 (step S72). The control device 21 determines whether the temperature measurement value is higher than the predetermined reference value (step S73). If the temperature measurement value is lower than or equal to the predetermined reference value (No in step S73), heat is not yet stored in the workpiece by irradiation with the laser beam L. Therefore, no special control is performed, and the current output of the laser beam L is maintained. The control device 21 determines whether the manufacturing process has been completed (step S76). If the manufacturing process has not been completed (No in step S76), the process returns to step S71. If the manufacturing process has been completed (Yes in step S76), the process is completed.

On the other hand, if the temperature measurement value is higher than the predetermined reference value (Yes in step S73), the machining point is irradiated with the laser beam L having an output lower than the current output while the wire W is fed to the machining point (step S74). That is, the control device 21 controls the irradiation unit so as to output the laser beam L having an output lower than the current output of the laser beam L. That is, the control device 21 controls the irradiation unit so as to reduce the output of the laser beam L. In one example, the output of the laser beam L with which a difference between the temperature measurement value and the predetermined reference value becomes 0 is obtained in advance, and on the basis of association information in which the difference between the temperature measurement value and the predetermined reference value is associated with the output of the laser beam L, the output of the laser beam L can be determined.

Thereafter, the control device 21 determines whether the manufacturing process has been completed (step S75). If the manufacturing process has not been completed (No in step S75), the process returns to step 872. If the manufacturing process has been completed (Yes in step S75), the process is completed.

In the fifth embodiment, the additive manufacturing apparatus 100e further includes the temperature measurement unit 30 that measures the temperature of the machining point. Then, in a case where the temperature measurement value of the machining point measured by the temperature measurement unit 30 is higher than the predetermined reference value, the control device 21 controls the irradiation unit so as to perform irradiation with the laser beam L having an output lower than the current output, that is, so as to reduce the output of the laser beam L. Consequently, the output of the laser beam L with which the machining point is irradiated can be made appropriate in consideration of heat storage to the machining point due to continuous irradiation with the laser beam L.

### Sixth Embodiment

The wire W is fed onto the workpiece, and at that time, the tip thereof is in contact with the machining point of the workpiece. When the wire W is fed from the wire spool 17 in that state, the wire W is caught by the underlayer such as the flux layer 52, which may cause peeling of the flux layer 52 or scratches on the underlying layer. Therefore, in a sixth embodiment, a case will be described where the wire W is prevented from being excessively fed onto the workpiece.

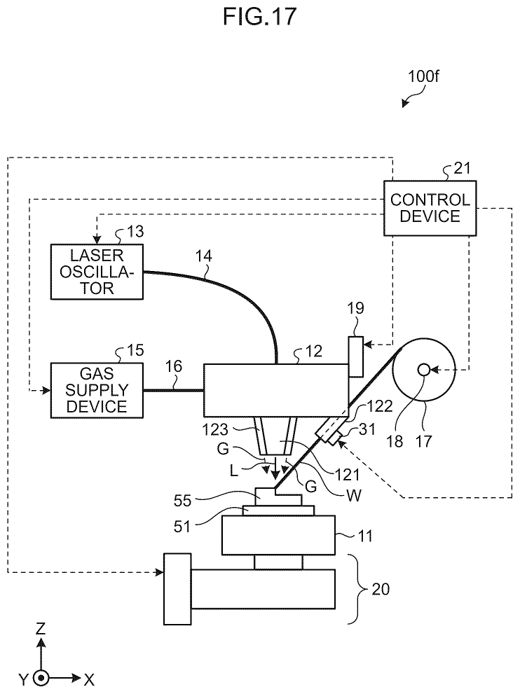

FIG. 17 is a diagram schematically illustrating an example of a configuration of an additive manufacturing apparatus according to the sixth embodiment. The same components as those in FIG. 1 will be denoted by the same reference numerals as those therein, descriptions thereof will be omitted, and differences from FIG. 1 will be described. An additive manufacturing apparatus 100f according to the sixth embodiment further includes a strain gauge 31 that detects a force applied to the wire nozzle 122. In a case where the wire W is in contact with the machining point, the wire W bends. When the wire W bends, the wire W comes into contact with the wire nozzle 122, and a force is applied to the wire nozzle 122. The strain gauge 31 measures the force applied to the wire nozzle 122. The strain gauge 31 outputs a strain measurement value which is a measurement result to the control device 21.

The strain gauge 31 is an example of a load measurement unit that measures a load applied to the wire W.

In a case where the strain measurement value from the strain gauge 31 is larger than a predetermined reference value, the control device 21 changes the feed rate of the wire W or changes the relative positions of the wire W and the base material 51 so that the strain measurement value becomes smaller than or equal to the reference value. Specifically, the control device 21 decreases the feed rate of the wire W, or moves the machining head 12 including the wire nozzle 122 in a direction away from the stage 11. In this example, the machining head 12 is provided with a movement mechanism in the Z-axis direction, and thus the machining head 12 is moved. However, in a case where the stage 11 is provided with the movement mechanism in the Z-axis direction, the stage 11 may be moved.

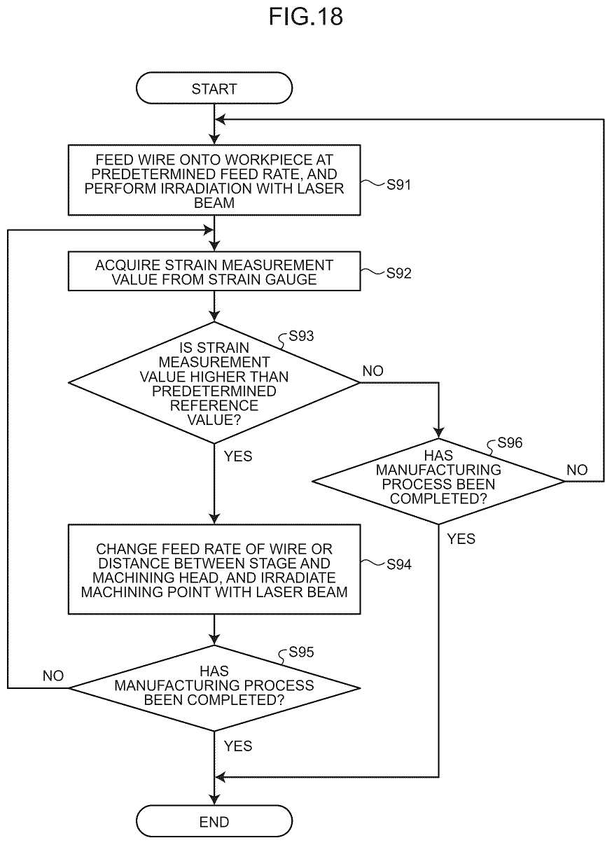

FIG. 18 is a flowchart illustrating an example of a procedure of an additive manufacturing method according to the sixth embodiment. Here, the process at the time of forming the first aluminum-containing metal layer 53 in step S15 in FIG. 3 or step S32 in FIG. 10, or the process at the time of forming the second aluminum-containing metal layer 54 in step S16 in FIG. 3, step S34 in FIG. 10, or step S53 in FIG. 12 is illustrated.

First, the wire W is fed onto the workpiece at a predetermined feed rate, and the machining point is irradiated with the laser beam L (step S91). That is, the control device 21 controls the material feed unit so as to feed the wire W to the machining point at the predetermined feed rate, and controls the irradiation unit so as to irradiate the machining point including the tip of the wire W with the laser beam L. At the start of machining, the predetermined feed rate is a preset feed rate of the wire W. In a case where the feed rate of the wire W is decreased in step S94 described later, the predetermined feed rate is the feed rate of the wire W determined in step S94 which is most recent.

Next, the control device 21 acquires a strain measurement value from the strain gauge 31 (step S92). The control device 21 determines whether the strain measurement value is higher than the predetermined reference value (step S93). If the strain measurement value is lower than or equal to the predetermined reference value (No in step S93), a force that causes damage to the workpiece is not applied by the wire W. Therefore, no special control is performed. The control device 21 determines whether the manufacturing process has been completed (step S96). If the manufacturing process has not been completed (No in step S96), the process returns to step S91. If the manufacturing process has been completed (Yes in step S96), the process is completed.

On the other hand, if the strain measurement value is higher than the predetermined reference value (Yes in step S93), the feed rate of the wire W or a distance between the stage 11 and the machining head 12 is changed, and the machining point is irradiated with the laser beam L (step 894). Specifically, the control device 21 controls the material feed unit so that the feed rate is decreased to be lower than the current value, or controls the head drive device 19 so that the machining head 12 moves in a direction away from the workpiece.

Thereafter, the control device 21 determines whether the manufacturing process has been completed (step S95). If the manufacturing process has not been completed (No in step S95), the process returns to step S92. If the manufacturing process has been completed (Yes in step 895), the process is completed.

In the above description, the case has been described where the control device 21 changes the feed rate of the wire W or the distance between the stage 11 and the machining head 12 in the case where the strain measurement value of the wire W is larger than the predetermined reference value. In the case where the strain measurement value of the wire W is larger than the predetermined reference value, it is considered that the tip of the wire W is in contact with the workpiece in a state where the wire W is hard, that is, not melted. Therefore, it is also possible to perform control to soften the wire W. In one example, the control device 21 may increase the output of the laser beam L in addition to or instead of the above control. As illustrated in FIG. 13, in a case where a current can be applied to the wire W, the control device 21 may increase the current applied to the wire W in addition to or instead of the above control. Such control makes it possible to soften the wire W and reduce a load to be applied to the workpiece by the wire W.

As described above, in the sixth embodiment, in the step of layering the first aluminum-containing metal layer 53 and the step of layering the second aluminum-containing metal layer 54, the load received by the wire W from the layering surface of the underlying layer is measured. Then, in a case where the load is larger than a predetermined reference value, the feed rate of the wire W is changed, or the relative positions of the wire W and the base material 51 are changed. The additive manufacturing apparatus 100f in FIG. 17 further includes the strain gauge 31 that measures a force applied to the wire nozzle 122 assuming that the load received by the wire W from the layering surface is equal to the force applied to the wire nozzle 122. Consequently, it is possible to prevent the wire W in contact with the workpiece from applying stress to the workpiece more than necessary.. As a result, it is possible to prevent the occurrence of scratches, peeling of the underlying layer, and the like, due to the wire W scratching the workpiece.

### Seventh Embodiment

In a case where the output of the laser beam L is excessive, in a case where the current applied to the wire W is excessive, in a case where the feed rate of the wire W is insufficient, or in a case where the gap, which is a distance between the tip position of the wire W and the layering surface, is larger than assumed, there is a possibility of the occurrence of fusing in which the wire W is torn. In a case where fusing occurs, molten metal forms droplets to fall onto the workpiece. The droplets of the fallen molten metal solidified on the workpiece have collapsed shapes unlike the shape in a case where the wire W is melted and solidified on the workpiece. In addition, there is also a possibility that the shielding gas G is blown off by an impact when the molten metal droplets fall onto the workpiece, and thereby an effect of preventing oxidation cannot be obtained. In a seventh embodiment, an additive manufacturing method will be described in which the presence or absence of the possibility of the occurrence of fusing is detected, and the output of the laser beam L, the feed rate of the wire W, or the current of the wire W is controlled on the basis of a detection result.

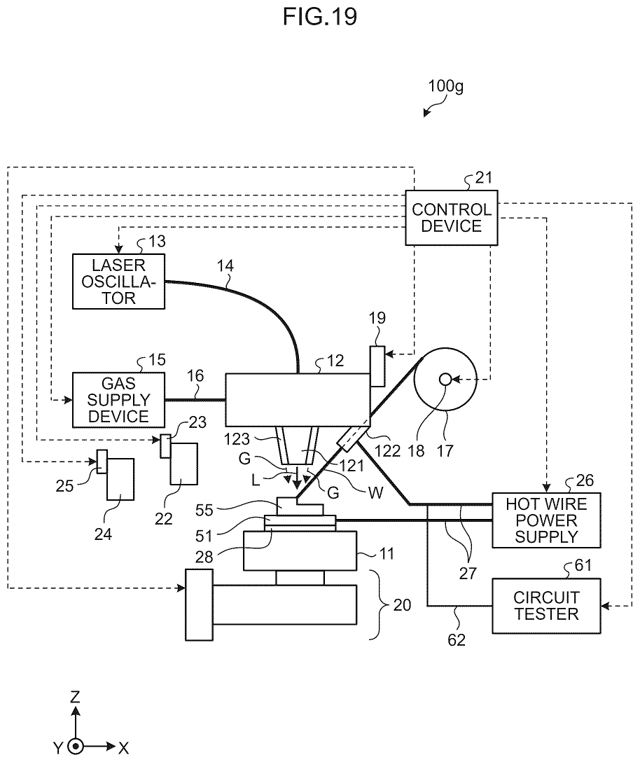

FIG. 19 is a diagram schematically illustrating an example of a configuration of an additive manufacturing apparatus according to the seventh embodiment. The same components as those in FIGS. 1 and 13 will be denoted by the same reference numerals as those therein, descriptions thereof will be omitted, and differences from FIGS. 1 and 13 will be described. An additive manufacturing apparatus 100g according to the seventh embodiment includes a mechanism for measuring a current flowing through the wire W or a voltage applied to the wire W, which is a difference from that of the additive manufacturing apparatus 100c according to the third embodiment. That is, in the seventh embodiment, the additive manufacturing apparatus 100g further includes a circuit tester 61 and a probe 62.

The circuit tester 61 measures a current flowing through the wire W or a voltage applied to the wire W. As described above, the current cable 27 is connected between the hot wire power supply 26 and the wire nozzle 122 and between the base material 51 and the hot wire power supply 26, and the tip of the wire W fed from the wire nozzle 122 is in contact with the workpiece. Therefore, a current is flowing through the wire W during the manufacturing process. The circuit tester 61 measures the current flowing through the wire W or the voltage applied to the wire W. The circuit tester 61 is connected to the control device 21 via wiring, and outputs a measurement value which is a result of the measurement to the control device 21.

The probe 62 is a probe electrically connected to the circuit tester 61 and used when measuring the current flowing through the wire W or the voltage applied to the wire W. In this example, the probe 62 is electrically connected to the current cable 27 that connects the hot wire power supply 26 and the wire nozzle 122. Note that the probe 62 may be electrically connected to the current cable 27 that connects the hot wire power supply 26 and the base material 51.

In a case where the wire W is in a normal state, the current flowing through the wire W or the voltage applied to the wire W indicates a value determined depending on the cross-sectional area, length, material, and the like of the wire W. However, in a case where the wire W is about to fuse, when the molten wire W is about to be separated from the workpiece, a contact volume between the molten wire W and the workpiece decreases, which results in an increase in resistivity. When the resistivity of the wire W increases, the current flowing through the wire W reduces, and the voltage applied to the wire W increases. When the molten wire W is completely separated from the workpiece, the resistance becomes infinite, and the current does not flow. That is, the possibility of the occurrence of fusing can be determined by referring to the measurement value of the current or the voltage of the wire W. Therefore, in the seventh embodiment, the control device 21 determines the possibility of the occurrence of fusing on the basis of the measurement value of the current or the voltage of the wire W from the circuit tester 61, and controls the output of the laser beam L, the feed rate of the wire W, or the current of the wire W when there is the possibility of the occurrence of fusing.

In a case where the control is performed by using the measurement value of the current, the control device 21 determines whether the measurement value of the current from the circuit tester 61 has decreased beyond margin of error as compared with a fusing determination reference value which is a current value in a case where there is no occurrence of fusing. The fusing determination reference value can be a statistical value such as an average value of current values of the wire W in the case where there is no occurrence of fusing, or a set value set at the time of the manufacturing process. In a case where the measurement value of the current coincides with the fusing determination reference value, the control device 21 determines that there is no occurrence of fusing, and continues the manufacturing process under the current machining condition. In a case where the measurement value of the current is lower than the fusing determination reference value, the control device 21 determines that fusing is about to occur, and controls the laser oscillator 13 so as to reduce the output of the laser beam L, controls the rotary motor 18 of the wire spool 17 so as to increase the feed rate of the wire W, or reduces the current for heating the wire W. Consequently, the fusing of the wire W can be prevented. At that time, the control device 21 may change the amount of reduction in the output of the laser beam L, the amount of increase in the feed rate of the wire W, or the amount of reduction in the current for heating the wire W depending on the magnitude of the difference between the fusing determination reference value and the measurement value of the current. In a case where the measurement value of the current becomes 0, the control device 21 stops the manufacturing process in order to indicate that fusing has occurred in the wire W.

In a case where the control is performed by using the measurement value of the voltage, the control device 21 determines whether the measurement value of the voltage from the circuit tester 61 has increased beyond margin of error as compared with a fusing determination reference value which is a voltage value in a case where there is no occurrence of fusing. The fusing determination reference value can be a statistical value such as an average value of acquired voltage values, which are values of the voltage of the wire W in a case where there is no occurrence of fusing, acquired in advance. In a case where the measurement value of the voltage coincides with the fusing determination reference value, the control device 21 determines that there is no occurrence of fusing, and continues the manufacturing process under the current machining condition. In a case where the measurement value of the voltage is higher than the fusing determination reference value, the control device 21 determines that fusing is about to occur, and controls the laser oscillator 13 so as to reduce the output of the laser beam L, controls the rotary motor 18 of the wire spool 17 so as to increase the feed rate of the wire W, or reduces the current of the wire W. Consequently, the fusing of the wire W can be prevented. At that time, the control device 21 may change the amount of reduction in the output of the laser beam L, the amount of increase in the feed rate of the wire W, or the amount of reduction in the current for heating the wire W depending on the magnitude of the difference between the fusing determination reference value and the measurement value of the voltage.

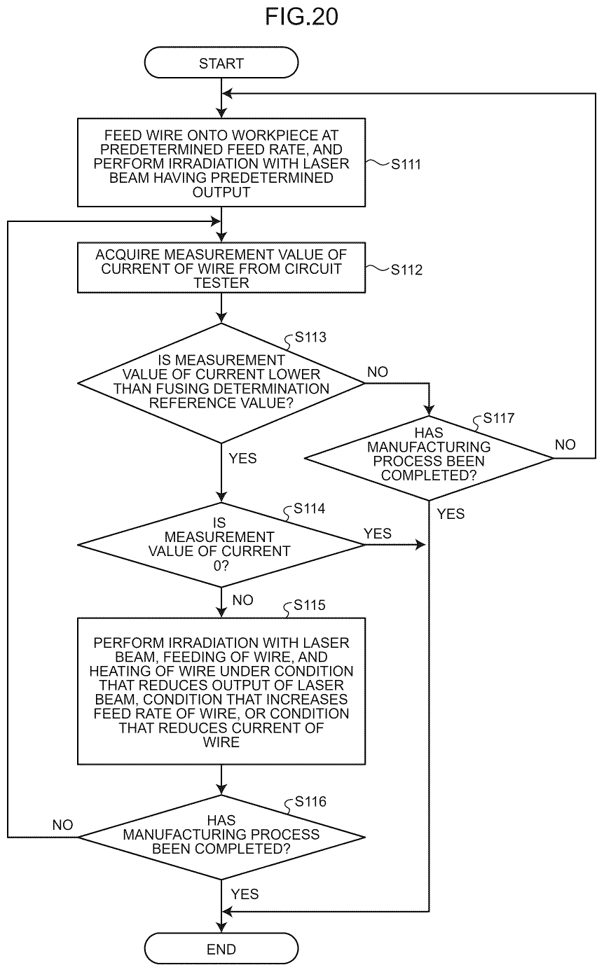

FIG. 20 is a flowchart illustrating an example of a procedure of an additive manufacturing method according to the seventh embodiment. Here, a case is illustrated where a process of controlling the output of the laser beam L is performed by using a current applied to the wire W at the time of forming the first aluminum-containing metal layer 53 or the second aluminum-containing metal layer 54.

First, the wire W is fed onto the workpiece at a predetermined feed rate, and irradiation with the laser beam L having a predetermined output is performed (step S111). That is, the control device 21 controls the material feed unit so as to feed the wire W to the machining point at the predetermined feed rate, and controls the irradiation unit so as to irradiate the machining point with the laser beam L having the predetermined output. At the start of machining, the predetermined feed rate is a preset feed rate of the wire W. In a case where the feed rate is decreased in step S114 described later, the predetermined feed rate is the feed rate of the wire W determined in step S114 which is most recent. At the start of machining, the predetermined output is a preset output of the laser beam L. In a case where the output of the laser beam L is reduced in step S114 described later, the predetermined output is the output of the laser beam L determined in step S114 which is most recent.

The circuit tester 61 measures the current flowing through the wire W during the manufacturing process. The control device 21 acquires a measurement value of the current of the wire W from the circuit tester 61 (step S112). The control device 21 determines whether the measurement value of the current is lower than the fusing determination reference value (step S113).

If the measurement value of the current is lower than the fusing determination reference value (Yes in step S113), the control device 21 determines whether the measurement value of the current is 0 (step S114). If the measurement value of the current is not 0 (No in step S114), the control device 21 performs irradiation with the laser beam L, feeding of the wire W, and heating of the wire W under a condition that reduces the output of the laser beam L, a condition that increases the feed rate of the wire W, or a condition that reduces the current of the wire W (step S115). Thereafter, the control device 21 determines whether the manufacturing process has been completed (step S116). If the manufacturing process has not been completed (No in step S116), the process returns to step S112. If the manufacturing process has been completed (Yes in step S116), the process is completed. If the measurement value of the current is 0 in step S114 (Yes in step S114), the process is completed.

On the other hand, if the measurement value of the current is higher than or equal to the fusing determination reference value (No in step S113), the control device 21 determines whether the manufacturing process has been completed (step S117). If the measurement value of the current is higher than or equal to the fusing determination reference value, there is no occurrence of fusing in the wire W by irradiation with the laser beam L. Therefore, the feed rate of the wire W, the output of the laser beam L, and the current of the wire W in a case where the wire W is heated, which are currently employed, are maintained, and no special control is performed. Therefore, if the manufacturing process has not been completed (No in step S117), the process returns to step S111. If the manufacturing process has been completed (Yes in step S117), the process is completed.

FIG. 20 illustrates the example in which whether fusing has occurred is determined by using the measurement value of the current of the wire W. However, whether fusing has occurred may be determined by using the measurement value of the voltage. In that case, if the measurement value of the voltage is higher than the fusing determination reference value in step S113, the process proceeds to step S115. In addition, if the measurement value of the voltage is lower than or equal to the fusing determination reference value, the process proceeds to step S117.

In the seventh embodiment, the additive manufacturing apparatus 100g further includes the circuit tester 61 that measures the current flowing through the wire W or the voltage applied to the wire W. Then, in a case where the measurement value of the current of the wire W measured by the circuit tester 61 is lower than the fusing determination reference value or in a case where the measurement value of the voltage of the wire W is higher than the fusing determination reference value, the control device 21 performs output of the laser beam L, feeding of the wire W, and heating of the wire W under the condition that reduces the output of the laser beam L, the condition that increases the feed rate of the wire W, or the condition that reduces the current of the wire W.

Consequently, the occurrence of the fusing of the wire W can be prevented.

### Eighth Embodiment

In an eighth embodiment, an additive manufacturing method will be described in which during the manufacturing process, the position of the tip of the wire W is detected, and the feed rate of the wire W is controlled on the basis of the detected position of the tip of the wire W and the height of the workpiece.

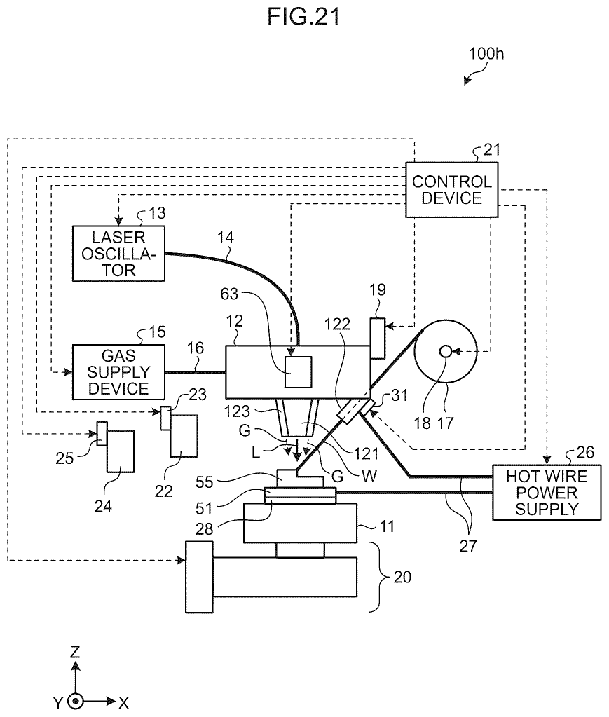

FIG. 21 is a diagram schematically illustrating an example of a configuration of an additive manufacturing apparatus according to the eighth embodiment. The same components as those in FIGS. 1, 11, 13, and 17 will be denoted by the same reference numerals as those therein, descriptions thereof will be omitted, and differences from FIGS. 1, 11, 13, and 17 will be described. An additive manufacturing apparatus 100h according to the eighth embodiment further includes the strain gauge 31 and an imaging unit 63 that images a machining point which is an irradiation position of the laser beam L on the workpiece in addition to the configuration of FIG. 13. An example of the imaging unit 63 is a camera that images a region including the machining point. The imaging unit 63 may be attached inside the machining head 12 or may be attached outside the machining head 12. In the case where the imaging unit 63 is attached inside the machining head 12, it is desirable to attach the imaging unit 63 so as to have the same axis as the output of the laser beam L. Consequently, imaging can be performed from directly above the machining point, and thus a more accurate position of the wire W can be acquired. The imaging unit 63 outputs image data which is an imaging result of the region including the machining point to the control device 21.

The control device 21 adjusts at least one of the feed rate of the wire W, the current applied to the wire W, or the output of the laser beam L depending on the position of the tip of the wire W and the position of the machining point obtained from the image data obtained by imaging the region including the machining point which is the irradiation position of the laser beam L, and the strain measurement value acquired from the strain gauge 31. Specifically, the control device 21 performs an image analysis on the image data from the imaging unit 63, and extracts the position of the tip of the wire W and the machining point. The control device 21 determines, with reference to the machining point, whether the position of the tip of the wire W is at the machining point, passes through the machining point, or is on a wire nozzle 122 side with respect to the machining point. In addition, the control device 21 compares the strain measurement value with the predetermined reference value. Then, the control device 21 adjusts at least one of the feed rate of the wire W, the current applied to the wire W, or the output of the laser beam L depending on the position of the tip of the wire W with reference to the machining point and the magnitude of the strain measurement value with respect to the reference value. In this example, the force applied to the wire nozzle 122 is detected by the strain gauge 31, but any device other than the strain gauge 31 may be used as long as the load applied to the wire W can be measured by the device. That is, the control device 21 may be any device that measures the load received by the wire W from the underlying layer, and adjusts the feed rate of the wire W and the current applied to the wire W depending on the position of the tip of the wire W with reference to the machining point and the magnitude of the load with respect to the predetermined reference value.

In a case where the position of the tip of the wire W is at the machining point and the strain measurement value is the reference value, the feed rate of the wire W and the current applied to the wire W which are currently employed are appropriate, and thus the control device 21 maintains that state. Note that the reference value may have a certain range.

In a case where the position of the tip of the wire W is on the wire nozzle 122 side with respect to the machining point and the strain measurement value is higher than the reference value, it is considered that the wire W is not about to fuse, but the height of the workpiece is higher than assumed, that is, the aluminum-containing metal layer is layered higher than assumed, and the tip of the wire W is present on the wire nozzle 122 side. That is, the tip of the wire W is plunged into the workpiece in the vicinity of the machining point higher than assumed. In such a case, the control device 21 decreases the feed rate of the wire W or increases the current applied to the wire W.

In a case where the position of the tip of the wire W is on the wire nozzle 122 side with respect to the machining point and the strain measurement value is lower than the reference value, it can be determined that the wire W is about to fuse. Therefore, the control device 21 increases the feed rate of the wire W, reduces the current applied to the wire W, or reduces the output of the laser beam L.

In a case where the position of the tip of the wire W has passed the machining point and the strain measurement value is higher than the reference value, it can be determined that the current feed rate of the wire W is too high and thus the wire W is plunged beyond the machining point backward. Therefore, the control device 21 decreases the feed rate of the wire W or increases the current applied to the wire W.

In a case where the position of the tip of the wire W has passed the machining point and the strain measurement value is lower than the reference value, the height of the workpiece in the vicinity of the machining point is lower than assumed, that is, the aluminum-containing metal layer is layered lower than assumed, and the position of the tip of the wire W is inserted beyond the machining point backward, but not the extent that the tip of the wire W is plunged into the workpiece. In such a case, since the wire W is not plunged into the workpiece, the control device 21 decreases the feed rate of the wire W, but regarding the current applied to the wire W, reduction in the current may result in fusing, and thus nothing is performed and the current state is maintained.

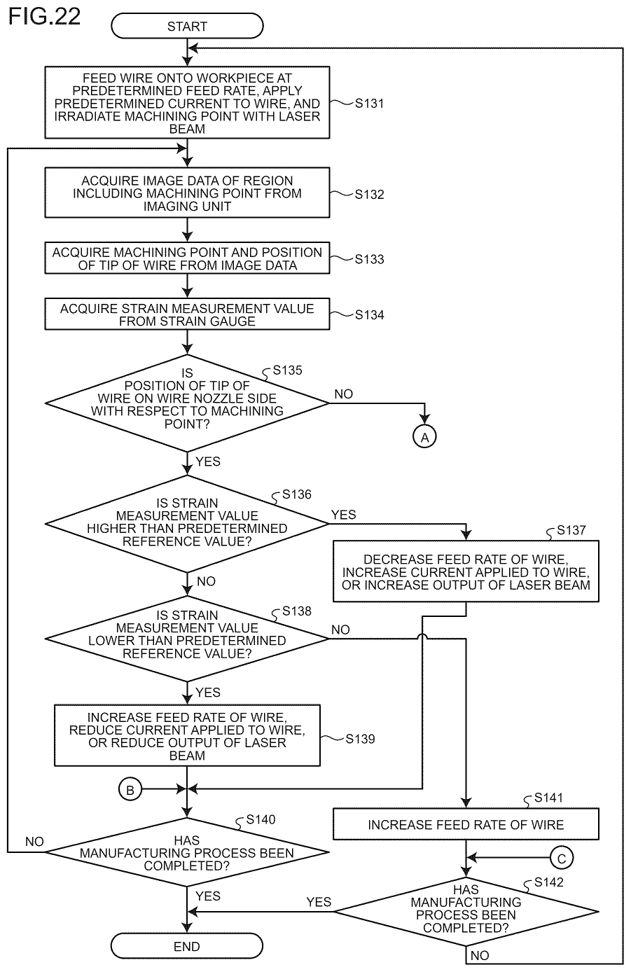

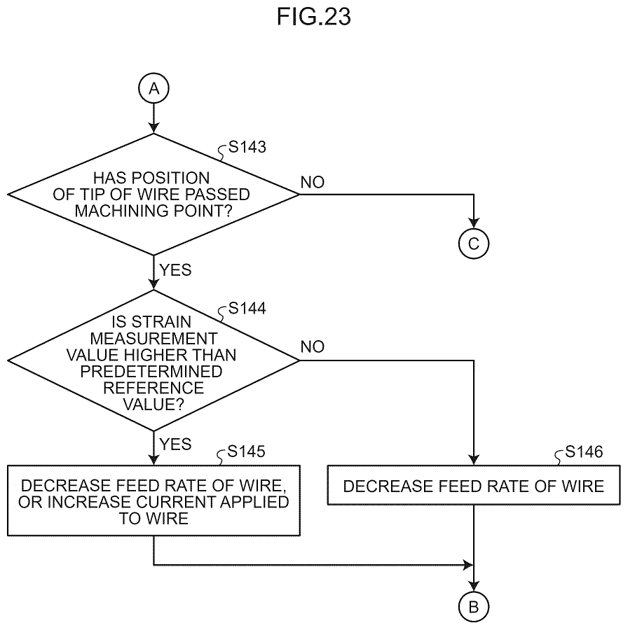

FIGS. 22 and 23 are each a flowchart illustrating an example of a procedure of an additive manufacturing method according to the eighth embodiment. Here, a process of controlling the feed rate of the wire W and the current applied to the wire W at the time of forming the first aluminum-containing metal layer 53 or the second aluminum-containing metal layer 54 is illustrated.

First, the wire W is fed onto the workpiece at a predetermined feed rate, a predetermined current is applied to the wire W, and the machining point is irradiated with the laser beam L (step S131). That is, the control device 21 controls the material feed unit so as to feed the wire W to the machining point at the predetermined feed rate, controls the hot wire power supply 26 so as to apply the predetermined current to the wire W, and controls the irradiation unit so as to irradiate the machining point with the laser beam L. At the start of machining, the predetermined feed rate is a preset feed rate of the wire W. In a case where the feed rate of the wire W is changed in step S137, step S139, step S141, step S145, or step S146 described later, the predetermined feed rate is the feed rate of the wire W determined in step S137, step S139, step S141, step S145, or step S146, which is most recent. At the start of machining, the predetermined current is a preset current applied to the wire W. In a case where the current applied to the wire W is changed in step S137, step S139, or step S145 described later, the predetermined current is the current applied to the wire W determined in step S137, step S139, or step S145, which is most recent.

Next, the control device 21 acquires image data of a region including the machining point from the imaging unit 63 (step S132). The control device 21 performs an image analysis on the image data, and acquires the machining point and the position of the tip of the wire W from the image data (step S133). In addition, the control device 21 acquires a strain measurement value from the strain gauge 31 (step S134).

Thereafter, the control device 21 determines whether the position of the tip of the wire W is on the wire nozzle 122 side with respect to the machining point (step S135). If the position of the tip of the wire W is on the wire nozzle 122 side with respect to the machining point (Yes in step S135), the control device 21 determines whether the strain measurement value is higher than the predetermined reference value (step S136). If the strain measurement value is higher than the predetermined reference value (Yes in step S136), the control device 21 decreases the feed rate of the wire W to be lower than the current feed rate, increases the current applied to the wire W, or increases the output of the laser beam L (step S137).

If the strain measurement value is not higher than the predetermined reference value (No in step S136), the control device 21 determines whether the strain measurement value is lower than the predetermined reference value (step S138). If the strain measurement value is lower than the predetermined reference value (Yes in step S138), the control device 21 increases the feed rate of the wire W to be higher than the current feed rate, reduces the current applied to the wire W, or reduces the output of the laser beam L (step S139). This is because the wire W is about to fuse.

Thereafter or after step S137, the control device 21 determines whether the manufacturing process has been completed (step S140). If the manufacturing process has not been completed (No in step S140), the process returns to step S132. If the manufacturing process has been completed (Yes in step S140), the process is completed.

If the strain measurement value is not lower than the predetermined reference value in step S138 (No in step S138), the tip position of the wire W is on the wire nozzle 122 side, but the strain measurement value is in an appropriate range. In that case, the control device 21 increases the feed rate of the wire W (step S141). Thereafter, the control device 21 determines whether the manufacturing process has been completed (step S142). If the manufacturing process has not been completed (No in step S142), the process returns to step S131. If the manufacturing process has been completed (Yes in step S142), the process is completed.

If the position of the tip of the wire W is not on the wire nozzle 122 side with respect to the machining point in step S135 (No in step S135), the control device 21 determines whether the position of the tip of the wire W has passed the machining point (step S143). If the position of the tip of the wire W has passed the machining point (Yes in step S143), the control device 21 determines whether the strain measurement value is higher than the predetermined reference value (step S144). If the strain measurement value is higher than the predetermined reference value (Yes in step S144), the control device 21 decreases the feed rate of the wire W to be lower than the current feed rate, or increases the current applied to the wire W (step S145).

If the strain measurement value is not higher than the predetermined reference value (No in step S144), the control device 21 decreases the feed rate of the wire W to be lower than the current feed rate (step S146). Thereafter, the process proceeds to step S140.

If the position of the tip of the wire W has not passed the machining point in step S143 (No in step S143), the position of the tip of the wire W is at the machining point. In that case, since the feed rate of the wire W and the current applied to the wire W are appropriate, no special control is performed, and the current feed rate is maintained. Thereafter, the process proceeds to step S142.

The eighth embodiment includes the strain gauge 31 that measures the load applied to the wire W, and the imaging unit 63 that can image the position of the wire W during the manufacturing process. The control device 21 acquires the machining point and the position of the tip of the wire W from the image data imaged by the imaging unit 63. Then, the control device 21 adjusts the feed rate of the wire W, the current applied to the wire W, or the output of the laser beam L from a combination of the position of the tip of the wire W and the load applied to the wire W. Consequently, the fusing or excessive plunging of the wire W can be prevented.

In the above description, the state of the wire W being plunged into the workpiece is detected by the strain gauge 31, but may be detected by other methods. In one example, the additive manufacturing apparatus 100h may further include an imaging unit that obliquely monitors the machining point, instead of the strain gauge 31. This imaging unit is different from the imaging unit 63. In that case, it is sufficient to acquire the plunged state of the wire W including the height of the workpiece from the image imaged by the imaging unit.

### Ninth Embodiment

In a ninth embodiment, an additive manufacturing method will be described in which during the manufacturing process, the temperature of the tip of the wire W is measured, and the output of the laser beam L or the feed rate of the wire W is controlled on the basis of the measured temperature of the tip of the wire W.

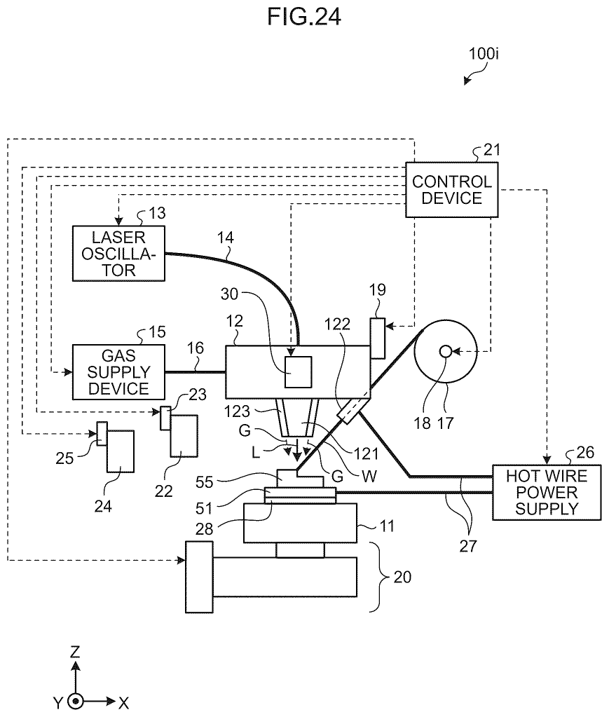

FIG. 24 is a diagram schematically illustrating an example of a configuration of an additive manufacturing apparatus according to the ninth embodiment. The same components as those in FIGS. 1, 11, 13, and 15 will be denoted by the same reference numerals as those therein, descriptions thereof will be omitted, and differences from FIGS. 1, 11, 13, and 15 will be described. An additive manufacturing apparatus 100i according to the ninth embodiment further includes the temperature measurement unit 30 that measures a temperature of a machining point which is an irradiation position of the laser beam L on the workpiece in addition to the configuration of FIG. 13. The temperature measurement unit 30 measures the temperature of the machining point which is the irradiation position of the laser beam L, but measures the temperature of the tip of the wire W in the ninth embodiment. However, since the tip of the wire W is fed to the center of the irradiation position of the laser beam L as a target, the temperature of the tip of the wire W can be considered to be the same as the temperature of the machining point. That is, in the ninth embodiment, the temperature of the machining point is the temperature of the tip of the wire W.

The control device 21 adjusts at least one of the output of the laser beam L, the feed rate of the wire W, or the current applied to the wire W on the basis of the temperature measurement value which is the measurement value of the temperature of the tip of the wire W acquired from the temperature measurement unit 30. Specifically, in a case where the temperature of the tip of the wire W measured by the temperature measurement unit 30 is higher than the predetermined reference value, the control device 21 performs at least one of a process of reducing the output of the laser beam L, a process of increasing the feed rate of the wire W, or a process of reducing the current of the wire W.

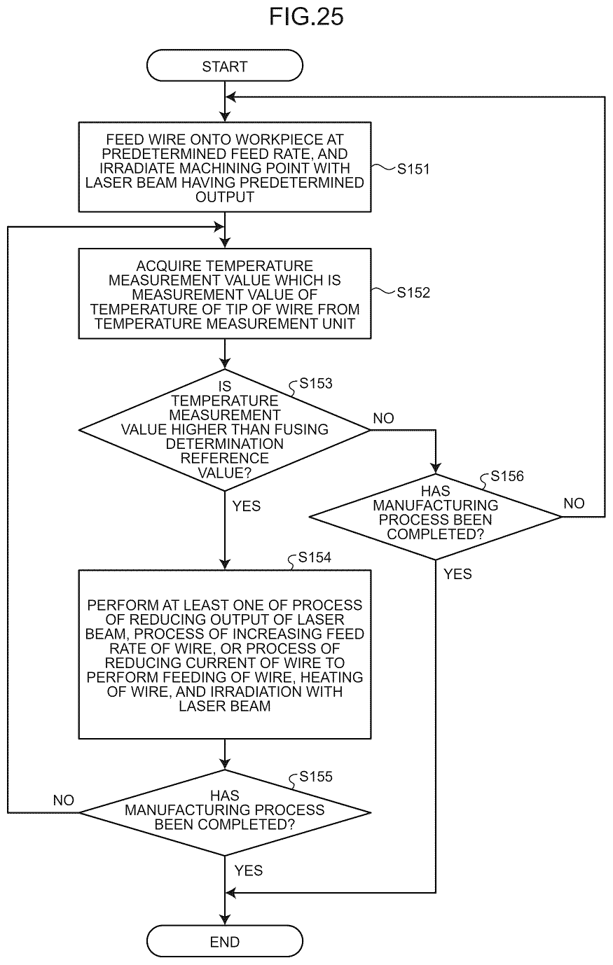

FIG. 25 is a flowchart illustrating an example of a procedure of an additive manufacturing method according to the ninth embodiment. First, the wire W is fed onto the workpiece at a predetermined feed rate, and the machining point is irradiated with the laser beam L having a predetermined output (step S151). That is, the control device 21 controls the material feed unit so as to feed the wire W to the machining point at the predetermined feed rate, and controls the irradiation unit so as to irradiate the machining point with the laser beam L having the predetermined output. At the start of machining, the predetermined feed rate is a preset feed rate of the wire W. In a case where the feed rate of the wire W is changed in step S154 described later, the predetermined feed rate is the feed rate of the wire W determined in step S154 which is most recent. At the start of machining, the predetermined output is a preset output of the laser beam L. In a case where the output of the laser beam L is changed in step S154 described later, the predetermined output is the output of the laser beam L determined in step S154 which is most recent.

The temperature measurement unit 30 always measures the temperature of the tip of the wire W during the manufacturing process. The control device 21 acquires a temperature measurement value which is a measurement value of the temperature of the tip of the wire W from the temperature measurement unit 30 (step S152). The control device 21 determines whether the temperature measurement value is higher than the predetermined fusing determination reference value (step S153). If the temperature measurement value is lower than or equal to the fusing determination reference value (No in step S153), heat is not yet stored in the workpiece by irradiation with the laser beam L. Therefore, no special control is performed, and the feed rate of the wire W and the output of the laser beam L which are currently employed are maintained. The control device 21 determines whether the manufacturing process has been completed (step S156). If the manufacturing process has not been completed (No in step S156), the process returns to step S151. If the manufacturing process has been completed (Yes in step S156), the process is completed.

On the other hand, if the temperature measurement value is higher than the fusing determination reference value (Yes in step S153), the control device 21 performs at least one of the process of reducing the output of the laser beam L, the process of increasing the feed rate of the wire W, or the process of reducing the current of the wire W to perform feeding of the wire W, heating of the wire W, and irradiation with the laser beam L (step S154). That is, the control device 21 controls the irradiation unit so as to output the laser beam L having an output lower than the current output of the laser beam L. Alternatively, the control device 21 controls the rotary motor 18 of the wire spool 17 so that the feed rate becomes higher than the current feed rate of the wire W. Alternatively, the control device 21 controls the hot wire power supply 26 so that the current becomes smaller than the current flowing through the wire W currently. By performing such control, the fusing of the wire W can be prevented.

Thereafter, the control device 21 determines whether the manufacturing process has been completed (step S155). If the manufacturing process has not been completed (No in step S155), the process returns to step S152. If the manufacturing process has been completed (Yes in step S155), the process is completed.

In the ninth embodiment, the additive manufacturing apparatus 100i further includes the temperature measurement unit 30 that measures the temperature of the tip of the wire W. Then, in a case where the temperature measurement value of the tip of the wire W measured by the temperature measurement unit 30 is higher than the fusing determination reference value, the control device 21 performs irradiation with the laser beam L while performing at least one of the process of reducing the output of the laser beam L, the process of increasing the feed rate of the wire W, or the process of reducing the current applied to the wire W. Consequently, it is possible to prevent fusing of the wire W due to continuous irradiation with the laser beam L.

### Tenth Embodiment

In a tenth embodiment, a case will be described where machine learning is performed by using a plurality of sensing results obtained by a detection unit during a manufacturing process and a manufacturing result, and whether it is a state in which fusing is likely to occur is determined from the sensing results.

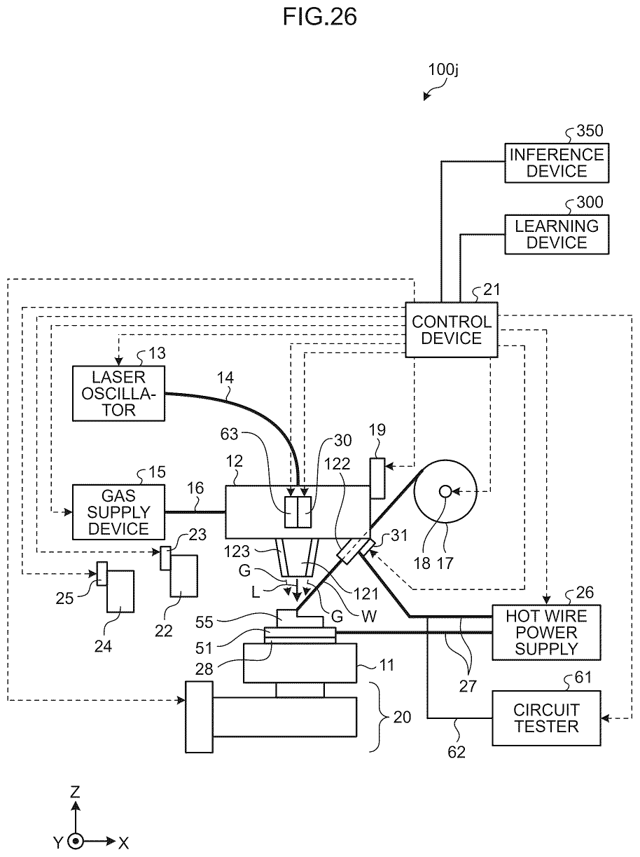

FIG. 26 is a diagram schematically illustrating an example of a configuration of an additive manufacturing apparatus according to the tenth embodiment. The same components as those described in the first to ninth embodiments are denoted by the same reference numerals as those therein, and descriptions thereof will be omitted. As illustrated in FIG. 26, an additive manufacturing apparatus 100j of the tenth embodiment includes the hot wire power supply 26, the current cables 27, the temperature measurement unit 30, the strain gauge 31, the circuit tester 61, the probe 62, and the imaging unit 63. In addition, the additive manufacturing apparatus 100j includes a learning device 300 and an inference device 350.

### Learning Phase

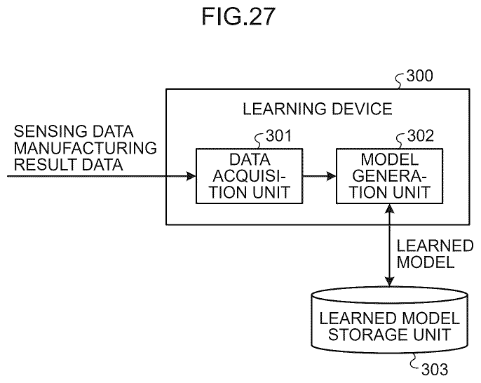

FIG. 27 is a block diagram illustrating an example of a configuration of the learning device in the additive manufacturing apparatus according to the tenth embodiment. The learning device 300 includes a data acquisition unit 301, a model generation unit 302, and a learned model storage unit 303.

The data acquisition unit 301 acquires sensing data and manufacturing result data as learning data.

The sensing data includes at least one of the temperature of the tip of the wire W during the manufacturing process and the temperature of the tip of the wire W before the manufacturing process acquired from the temperature measurement unit 30, the current flowing through the wire W or the voltage applied to the wire W acquired from the circuit tester 61, the position of the tip of the wire W extracted from the image data acquired from the imaging unit 63, or the load applied to the wire W acquired from the load measurement unit. The temperature of the tip of the wire W during the manufacturing process and the temperature of the tip of the wire W before the manufacturing process are data acquired from the temperature measurement unit 30. The current flowing through the wire W or the voltage applied to the wire W is data acquired from the circuit tester 61. The position of the tip of the wire W is data acquired from the imaging unit 63. An example of the load applied to the wire W acquired from the load measurement unit is a force applied to the wire nozzle 122 acquired from the strain gauge 31. The force applied to the wire nozzle 122 is data acquired from the strain gauge 31. Note that the data acquisition unit 301 may acquire each of these pieces of data from the temperature measurement unit 30, the circuit tester 61, the imaging unit 63, and the strain gauge 31, or may acquire each of these pieces of data from the control device 21 holding the above data. The sensing data may include at least one of the temperature of the tip of the wire W during the manufacturing process, the temperature of the tip of the wire W before the manufacturing process, the current flowing through the wire W or the voltage applied to the wire W, the position of the tip of the wire W, or the force applied to the wire nozzle 122.

The manufacturing result data is data indicating a result when the manufacturing process is performed by the additive manufacturing apparatus 100j by using a condition obtained by the sensing data. The manufacturing result data is stored in association with the sensing data. In one example, the manufacturing result data is stored in the control device 21. In this example, the manufacturing result data includes machining point positional relationship information and bead shape data including a width and a height, i.e., a bead shape. Among these pieces of the manufacturing result data, data used as correct data is data in which the machining point positional relationship information, which is a manufacturing result in a case where a load due to the plunging of the wire W into the workpiece is small, and the bead shape data of a bead having a target width and a target height are associated with each other. That is, the learning data is the sensing data in a case where the manufacturing result when the load is small and the bead having the target shape are obtained, and the manufacturing result data.

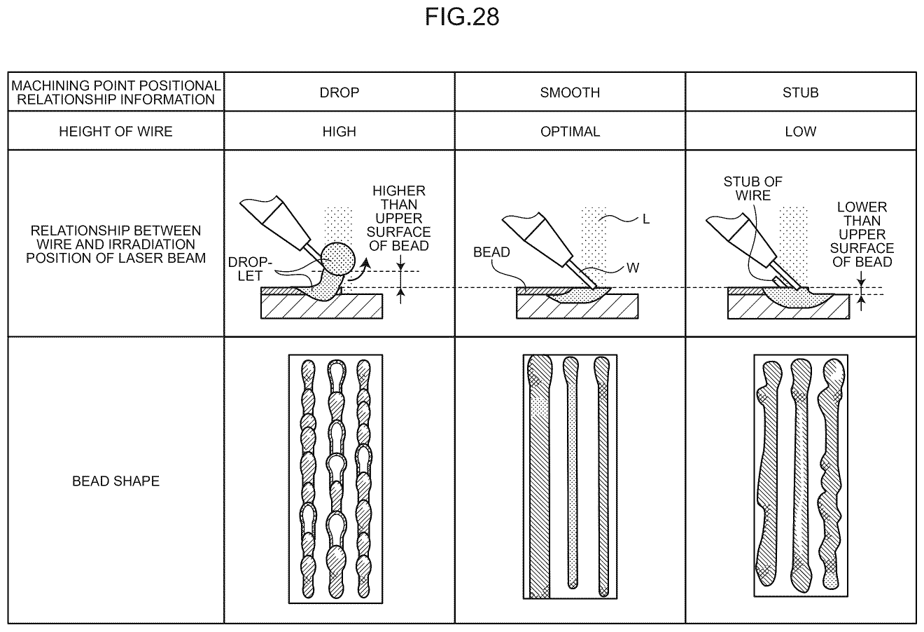

FIG. 28 is a diagram illustrating an example of machining point positional relationship information. The machining point positional relationship information is information indicating the relationship between the position of the tip of the wire W at the machining point and the irradiation position of the laser beam L at the time of acquisition of the sensing data. The machining point positional relationship information includes drop, smooth, and stub.

Smooth is a state in which a position where the wire W is melted is substantially at the same position as a position of an upper surface of a bead formed so far. That is, in smooth, the manufacturing process is performed in an optimal state in which the position of the tip of the wire W is present at the machining point which is the irradiation position of the laser beam L. When the manufacturing process is performed in such a state, the beads have uniform width and height as illustrated in the schematic diagram of bead shapes in FIG. 28. Therefore, the surfaces thereof are smooth, as well.

In drop, the position where the wire W is melted is higher than a position of an upper surface of a bead formed in the smooth state. That is, in drop, the manufacturing process is performed in a state where the position of the tip of the wire W is on the wire nozzle 122 side with respect to the machining point. When the manufacturing process is performed in such a state, the wire W is melted above the position of the upper surface of the bead, and forms droplets. Then, the droplets are solidified. In addition, the droplets splash upward to generate spatter. As a result, as illustrated in the bead shapes in FIG. 28, the widths of the beads are increased and the heights of the beads are also increased as compared with the case of smooth. In addition, since droplets having non-uniform sizes fall, the widths and heights of the beads are not uniform. Furthermore, in a case where it takes time for the droplets to fall, nothing is welded. That is, in a case where fusing occurs, a bead has a shape in which the bead is completely torn and round masses formed by splashing droplets are scattered around.

In stub, the position where the wire W is melted is lower than the position of the upper surface of the bead formed in the smooth state. That is, in stub, the manufacturing process is performed in a state where the position of the tip of the wire W has passed the machining point. When the manufacturing process is performed in such a state, the wire W is melted and solidified below the position of the upper surface of the bead. As a result, as illustrated in the bead shapes in FIG. 28, the widths of the beads are decreased and the heights of the bead are also decreased as compared with the case of smooth. In addition, since the melting of the wire W is non-uniform, the widths and the heights of the beads are not uniform but have irregularities. As a result, similarly to the case of drop, the surfaces of the beads are not smooth.

The control device 21 acquires the machining point positional relationship information indicating the relationship between the position of the tip of the wire W and the irradiation position of the laser beam L during the manufacturing process, and acquires bead shape data including the width and height of the bead after the manufacturing process. In one example, the machining point positional relationship information and the bead shape data are input to the control device 21 by a user of the additive manufacturing apparatus 100j. The machining point positional relationship information and the bead shape data are associated with each other to be used as the manufacturing result data. The data acquisition unit 301 acquires the manufacturing result data from the control device 21.

Returning to FIG. 27, the model generation unit 302 generates, by using the learning data, a learned model for inferring manufacturing result prediction information, which is a prediction result of the manufacturing process performed by the additive manufacturing apparatus 100j, from the sensing data of the additive manufacturing apparatus 100j. In other words, the model generation unit 302 learns the manufacturing result prediction information by using the learning data created on the basis of a combination of the sensing data and the manufacturing result data output from the data acquisition unit 301. That is, the model generation unit 302 generates a learned model that infers optimal manufacturing result prediction information from the sensing data and the manufacturing result data of the additive manufacturing apparatus 100j. Here, the learning data is data in which the sensing data and the manufacturing result data are associated with each other. The manufacturing result prediction information includes a predicted value of a manufacturing result predicted when the sensing data is used as input data, and a predicted value of a bead shape including a width and a height. The predicted value of the manufacturing result indicates machining point positional relationship information, and is specifically any one of drop, stub, or smooth. The model generation unit 302 uses, as the learning data, a combination of the sensing data in the case where the manufacturing result when the load is small and the bead having the target shape are obtained, and the correct data. Here, the correct data is, among pieces of the manufacturing result data, data in which the machining point positional relationship information, which is the manufacturing result in the case where the load due to the plunging of the wire W into the workpiece is small, and the bead shape data of a bead having a target width and a target height are associated with each other.

As a learning algorithm used by the model generation unit 302, a known algorithm such as supervised learning, unsupervised learning, or reinforcement learning can be used. As one example, a case will be described where a neural network is applied.

In one example, the model generation unit 302 learns the manufacturing result prediction information by so-called supervised learning in accordance with a neural network model. Here, supervised learning is a method in which sets of data each including an input and a label which is a result are given to the learning device 300, and thereby characteristics reside in the learning data are learned and results are inferred from inputs.

The neural network includes an input layer including a plurality of neurons, an intermediate layer including a plurality of neurons, and an output layer including a plurality of neurons. The intermediate layer is also referred to as a hidden layer, and may be include one layer or two or more layers.

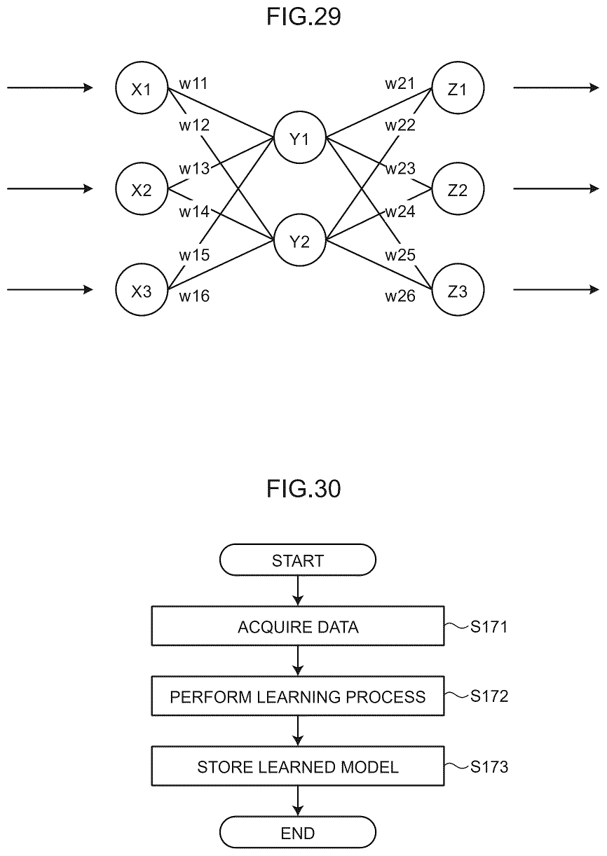

FIG. 29 is a diagram schematically illustrating an example of the neural network used by the model generation unit in FIG. 27. In one example, in a case of a three-layer neural network as illustrated in FIG. 29, when a plurality of inputs are input to input layers X1 to X3, values thereof are multiplied by weights denoted by w11 to w16 and input to intermediate layers Y1 and Y2. The weights will to w16 are referred to as weights w1 when no distinction is made therebetween. In addition, the results of the intermediate layers Y1 and Y2 are further multiplied by weights denoted by w21 to w26, and output from the output layers Z1 to Z3. The weights w21 to w26 are referred to as weights w2 when no distinction is made therebetween. The output results of the output layers 21 to Z3 vary depending on values of the weights w1 and w2.

In the tenth embodiment, the neural network learns the manufacturing result prediction information by so-called supervised learning in accordance with the learning data created on the basis of the combination of the sensing data and the manufacturing result data acquired by the data acquisition unit 301.

That is, the neural network learns by adjusting the weights W1 and W2 so that a result output from the output layer after inputting the sensing data to the input layer approximates the manufacturing result data which is the correct data.

The model generation unit 302 generates a learned model by executing learning as described above, and outputs the learned model.

Returning to FIG. 27, the learned model storage unit 303 stores the learned model output from the model generation unit 302.

Next, a process of learning by the learning device 300 will be described with reference to FIG. 30. FIG. 30 is a flowchart illustrating an example of a procedure of a learning process performed by the learning device of the additive manufacturing apparatus according to the tenth embodiment.

The data acquisition unit 301 acquires the sensing data in the case where the manufacturing result when the load is small and the bead having the target shape are obtained, and the manufacturing result data (step S171). Although the sensing data and the manufacturing result data have been simultaneously acquired, the sensing data and the manufacturing result data may be acquired at different timings as long as the sensing data and the manufacturing result data can be input in association with each other.

Next, the model generation unit 302 learns the manufacturing result prediction information by so-called supervised learning in accordance with the learning data created on the basis of the combination of the sensing data and the manufacturing result data acquired by the data acquisition unit 301, and generates a learned model using an estimation algorithm indicating a correlation between the temperature of the tip of the wire W during the manufacturing process, the temperature of the tip of the wire W before the manufacturing process, the current flowing through the wire W or the voltage applied to the wire W, the position of the tip of the wire W, and the force applied to the wire nozzle 122, and the machining point positional relationship information and the bead shape data (step S172).

Then, the learned model storage unit 303 stores the learned model generated by the model generation unit 302 (step S173). Thus, the process is completed.

### Utilization Phase

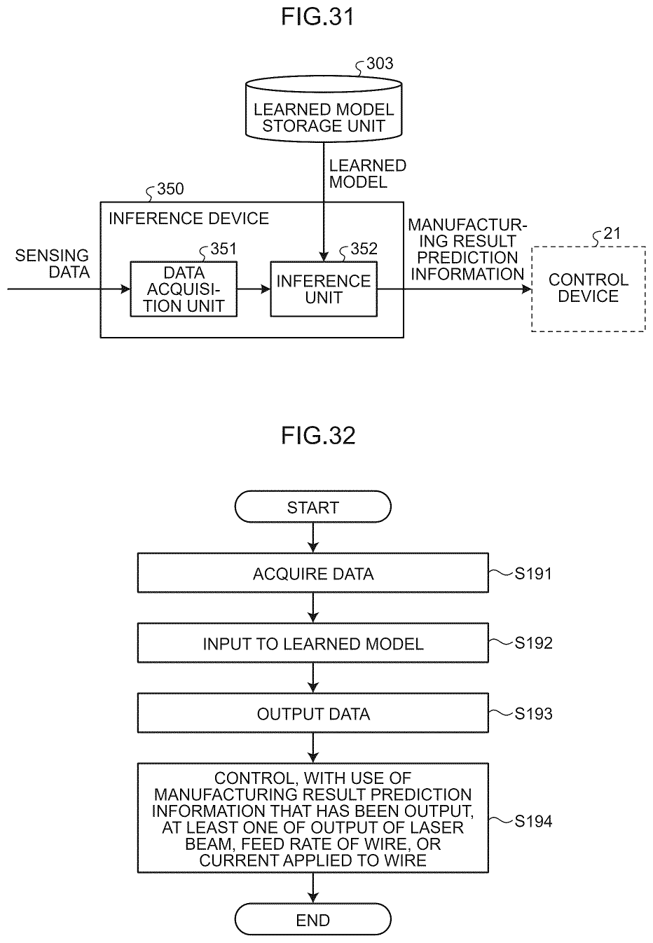

FIG. 31 is a diagram schematically illustrating an example of a configuration of the inference device in the additive manufacturing apparatus according to the tenth embodiment. The inference device 350 is a device that outputs, as the manufacturing result prediction information, a result obtained by inputting the sensing data to the learned model. The inference device 350 includes a data acquisition unit 351 and an inference unit 352.

The data acquisition unit 351 acquires the sensing data. The sensing data includes at least one of the temperature of the tip of the wire W during the manufacturing process and the temperature of the tip of the wire W before the manufacturing process acquired from the temperature measurement unit 30, the current flowing through the wire W or the voltage applied to the wire W acquired from the circuit tester 61, the position of the tip of the wire W extracted from the image data acquired from the imaging unit 63, or the load applied to the wire W acquired from the load measurement unit. The temperature of the tip of the wire W during the manufacturing process and the temperature of the tip of the wire W before the manufacturing process are data acquired from the temperature measurement unit 30. The current flowing through the wire W or the voltage applied to the wire W is data acquired from the circuit tester 61. The position of the tip of the wire W is data acquired from the imaging unit 63. An example of the load applied to the wire W acquired from the load measurement unit is a force applied to the wire nozzle 122 acquired from the strain gauge 31. The force applied to the wire nozzle 122 is data acquired from the strain gauge 31. Note that the data acquisition unit 351 may acquire each of these pieces of data from the temperature measurement unit 30, the circuit tester 61, the imaging unit 63, and the strain gauge 31, or may acquire each of these pieces of data from the control device 21 holding the above data. The sensing data may include at least one of the temperature of the tip of the wire W during the manufacturing process, the temperature of the tip of the wire W before the manufacturing process, the current flowing through the wire W or the voltage applied to the wire W, the position of the tip of the wire W, or the force applied to the wire nozzle 122.

The inference unit 352 infers the manufacturing result prediction information obtained by using the learned model. That is, by inputting the sensing data acquired by the data acquisition unit 351 to the learned model, the manufacturing result prediction information inferred from the sensing data can be output.

In the tenth embodiment, the case has been described where the learned model learned from the sensing data and the manufacturing result data of the additive manufacturing apparatus 100j is used. However, a learned model learned from sensing data and manufacturing result data of another additive manufacturing apparatus 100j or the like may be acquired from the outside, and the manufacturing result prediction information may be output on the basis of the learned model.

Next, a process for obtaining the manufacturing result prediction information by using the inference device 350 will be described with reference to FIG. 32. FIG. 32 is a flowchart illustrating an example of a procedure of an inference process performed by the inference device of the additive manufacturing apparatus according to the tenth embodiment.

First, the data acquisition unit 351 acquires sensing data (step S191). The sensing data is data including the temperature of the tip of the wire W during the manufacturing process, the temperature of the tip of the wire W before the manufacturing process, the current flowing through the wire W or the voltage applied to the wire W, the position of the tip of the wire W, and the force applied to the wire nozzle 122.

Next, the inference unit 352 inputs the sensing data to the learned model stored in the learned model storage unit 303, and obtains manufacturing result prediction information (step S192).

Thereafter, the inference unit 352 outputs the manufacturing result prediction information obtained by the learned model to the additive manufacturing apparatus 100j, specifically, the control device 21 of the additive manufacturing apparatus 100j (step S193).

Then, the control device 21 controls, with the use of the manufacturing result prediction information that has been output, at least one of the output of the laser beam L, the feed rate of the wire W, or the current applied to the wire W (step S194). In a case where the predicted value of the manufacturing result of the manufacturing result prediction information is smooth, in one example, the control device 21 maintains the current state. Alternatively, in a case where the predicted value of the bead shape of the manufacturing result prediction information is different from a reference value of a desired bead shape, the control device 21 adjusts at least one of the output of the laser beam L, the feed rate of the wire W, or the current applied to the wire W so that the bead shape approximates the reference value.

In a case where the predicted value of the manufacturing result of the manufacturing result prediction information is drop, there is a possibility that fusing has occurred. Therefore, the control device 21 adjusts at least one of the output of the laser beam L, the feed rate of the wire W, or the current applied to the wire W so that the predicted value of the bead shape approximates the reference value.

In a case where the predicted value of the manufacturing result of the manufacturing result prediction information is stub, there is a possibility that the wire W applies stress to the workpiece. Therefore, the control device 21 adjusts at least one of the output of the laser beam L, the feed rate of the wire W, or the current applied to the wire W so that the predicted value of the bead shape approximates the reference value.

Here, an example of control of the control device 21 in a case where the predicted value of the manufacturing result is drop or stub will be described. In a case where the current flowing through the wire W is lower than assumed or fluctuates, it can be determined that there is a possibility of the occurrence of fusing. In such a case, that is, in the case where the predicted value of the manufacturing result is drop, the wire W is about to fuse, and thus it is sufficient that the control device 21 performs at least one of a process of reducing the output of the laser beam L, a process of increasing the feed rate of the wire W, or a process of reducing the current applied to the wire W.

In a case where the voltage applied to the wire W is higher than assumed or fluctuates, it can be determined that there is a possibility of the occurrence of fusing. In such a case, that is, in the case where the predicted value of the manufacturing result is drop, in order to prevent fusing, it is sufficient that the control device 21 performs at least one of the process of reducing the output of the laser beam L, the process of increasing the feed rate of the wire W, or the process of reducing the current applied to the wire W.

In a case where the position of the tip of the wire W is on the wire nozzle 122 side with respect to the machining point, it can be determined that the wire W is about to fuse. In that case, that is, in the case where the predicted value of the manufacturing result is drop, it is sufficient that the control device 21 performs at least one of the process of reducing the output of the laser beam L, the process of increasing the feed rate of the wire W, or the process of reducing the current applied to the wire W.

In a case where the position of the tip of the wire W has passed the machining point, it can be determined that the melting of the wire W is insufficient. In that case, that is, in the case where the predicted value of the manufacturing result is stub, it is sufficient that the control device 21 performs at least one of a process of increasing the output of the laser beam L, a process of decreasing the feed rate of the wire W, or a process of increasing the current applied to the wire W.

In a case where the temperature of the tip of the wire W is higher than assumed, it can be determined that there is a possibility of the occurrence of fusing. In such a case, that is, in the case where the predicted value of the manufacturing result is drop, in order to lower the temperature of the tip of the wire W, it is sufficient that the control device 21 performs at least one of the process of reducing the output of the laser beam L, the process of increasing the feed rate of the wire W, or the process of reducing the current applied to the wire W.

In a case where the load of the wire W is higher than assumed, it can be determined that the melting of the wire W is insufficient. In such a case, that is, in the case where the predicted value of the manufacturing result is stub, in order to increase the temperature of the tip of the wire W, it is sufficient that the control device 21 performs at least one of the process of increasing the output of the laser beam L, the process of decreasing the feed rate of the wire W, or the process of increasing the current applied to the wire W. Consequently, it is possible to prevent the occurrence of fusing in the wire W or the stress applied by the wire W to the workpiece. Thus, the process is completed.

In the tenth embodiment, the case has been described where supervised learning is applied to the learning algorithm used by the model generation unit 302, but there is no limitation thereto. It is also possible to apply, as the learning algorithm, reinforcement learning, unsupervised learning, semi-supervised learning, or the like, other than supervised learning.

The model generation unit 302 may learn the manufacturing result prediction information in accordance with learning data created for a plurality of additive manufacturing apparatuses 100j. Note that the model generation unit 302 may acquire learning data from a plurality of additive manufacturing apparatuses 100j used in the same area, or may learn the manufacturing result prediction information by using learning data collected from a plurality of additive manufacturing apparatuses 100; that independently operate in different areas. In addition, it is also possible to add, in the middle of the learning, the additive manufacturing apparatus 100j as a target from which the learning data is collected, or to exclude the additive manufacturing apparatus 100j from such targets. Furthermore, the learning device 300 that has learned the manufacturing result prediction information for a certain additive manufacturing apparatus 100j may be applied to another additive manufacturing apparatus 100j, and the manufacturing result prediction information may be relearned and updated for the another additive manufacturing apparatus 100j.

As the learning algorithm used in the model generation unit 302, deep learning that learns extraction of feature quantities themselves can also be used, and machine learning may be performed in accordance with another known method, in one example, genetic programming, functional logic programming, or a support vector machine.

Furthermore, although the learning device 300 and the inference device 350 are used to learn the manufacturing result prediction information of the additive manufacturing apparatus 100j, in one example, the learning device 300 and the inference device 350 may be devices connected to the additive manufacturing apparatus 100j via a network and separate from the additive manufacturing apparatus 100j. Alternatively, the learning device 300 and the inference device 350 may be built in the control device 21 of the additive manufacturing apparatus 100j. Further alternatively, the learning device 300 and the inference device 350 may be present on a cloud server.

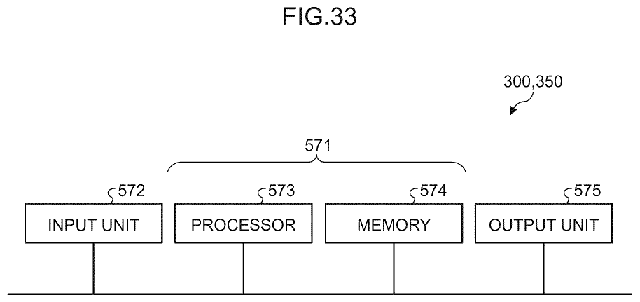

Next, hardware for realizing the learning device 300 and the inference device 350 according to the tenth embodiment will be described. FIG. 33 is a block diagram illustrating an example of a hardware configuration that realizes the learning device and the inference device in the additive manufacturing apparatus according to the tenth embodiment. FIG. 33 illustrates a configuration in a case where the learning device 300 and the inference device 350 are realized by a processing circuitry 571 including a processor 573 and a memory 574.

An input unit 572 is a circuit that receives input signals to the learning device 300 and the inference device 350 from the outside. An output unit 575 is a circuit that outputs signals generated by the learning device 300 and the inference device 350 to the outside. The data acquisition unit 301 of the learning device 300 and the data acquisition unit 351 of the inference device 350 are realized by the input unit 572. The input unit 572 is responsible for inputting the learned model. The output unit 575 is responsible for outputting the learned model in the learning device 300, and is responsible for outputting the manufacturing result prediction information in the inference device 350.

The processor 573 is a CPU. The processor 573 may be an arithmetic device, a microprocessor, a microcomputer, or a digital signal processor (DSP). The memory 574 is, in one example, a nonvolatile or volatile memory such as a RAM, a ROM, a flash memory, an erasable programmable read only memory (EPROM), or an electrically erasable programmable read only memory (EEPROM (registered trademark)). In a case where the learning device 300 and the inference device 350 are realized by the processor 573 and the memory 574, these components are realized by the processor 573 executing a program in which processes for operating as the learning device 300 and the inference device 350 are described. The program is stored in the memory 574 in advance. The program may be stored in a storage medium. The program may be installed on the processing circuitry 571 serving as the learning device 300 and the inference device 350 from another computer or a server device via a communication network.

As described above, according to the tenth embodiment, the learning device 300 generates the learned model that infers the manufacturing result prediction information on the basis of the learning data created on the basis of the combination of the sensing data in the case where the manufacturing result when the load is small and the bead having the target shape are obtained, and the manufacturing result data. The inference device 350 outputs the manufacturing result prediction information obtained by inputting the sensing data to the learned model. On the basis of the manufacturing result prediction information, the control device 21 adjusts at least one of the output of the laser beam L, the feed rate of the wire W, or the current applied to the wire W of the additive manufacturing apparatus 100j so that the predicted value of the bead shape becomes a value of a reference bead shape. Consequently, it is possible to prevent the occurrence of fusing in the wire W or the stress applied by the wire W to the workpiece more than necessary.

The configurations described in the above embodiments are merely examples and can be combined with other known technology, the embodiments can be combined with each other, and part of the configurations can be omitted or modified without departing from the gist thereof.

### REFERENCE SIGNS LIST

11 stage; 12, 12 a machining head; 13 laser oscillator; 14 fiber cable; 15 gas supply device; 16 pipe; 17, 178 wire spool; 18, 18a rotary motor; 19 head drive device; 20 rotation mechanism; 21 control device; 22 flux application device; 23 application drive device; 24 flux solidification device; 25 solidification drive device; 26 hot wire power supply; 27 current cable; 28 insulating member; 29 shaping optical system; 30 temperature measurement unit; 31 strain gauge; 51 base material; 52 flux layer; 52a liquid flux; 53 first aluminum-containing metal layer; 54 second aluminum-containing metal layer; 55 deposit; 61 circuit tester; 62 probe; 63 imaging unit; 100, 100a, 100b, 100c, 100d, 100e, 100f, 100g, 100h, 100i, 100j additive manufacturing apparatus; 121 beam nozzle; 122, 122a wire nozzle; 123 gas nozzle; 211 CPU; 212 RAM; 213 ROM; 214 storage device; 215 input/output interface; 216 bus; 300 learning device; 301, 351 data acquisition unit; 302 model generation unit; 303 learned model storage unit; 350 inference device; 352 inference unit; 571 processing circuitry; 572 input unit; 573 processor; 574 memory; 575 output unit; G shielding gas; L laser beam; W wire; Wa flux-cored wire.

1. An additive manufacturing method comprising:
applying a liquid flux to a base material made of metal containing iron;
heating the liquid flux applied to the base material to form a first flux layer that is a layer of the liquid flux that has been solidified;
layering a first aluminum-containing metal layer that is a layer obtained by irradiating a first wire that is a wire made of metal containing aluminum fed onto the first flux layer and the first flux layer with a laser beam, melting the first flux layer and the first wire, and solidifying the first flux layer and the first wire; and
layering, after formation of the first aluminum-containing metal layer, one or more second aluminum-containing metal layers that are layers obtained by irradiating a second wire that is a wire made of metal containing aluminum fed onto an underlying layer with the laser beam, melting the second wire, and solidifying the second wire.

2. An additive manufacturing method comprising:
layering a first aluminum-containing metal layer that is a layer obtained by irradiating a flux-containing metal wire that is a wire containing aluminum and a flux fed onto a base material made of metal containing iron with a laser beam, melting the flux-containing metal wire, and solidifying the flux-containing metal wire; and
layering, after formation of the first aluminum-containing metal layer, one or more second aluminum-containing metal layers that are layers obtained by irradiating a metal wire that is a wire containing aluminum and not containing the flux fed onto an underlying layer and a part of the underlying layer with the laser beam, melting the metal wire and the part of the underlying layer, and solidifying the metal wire and the part of the underlying layer.

3. The additive manufacturing method according to claim 1, wherein the layering the one or more second aluminum-containing metal layers includes:
applying the liquid flux onto an underlying layer;
heating the liquid flux applied to the underlying layer to form a second flux layer that is a layer of the liquid flux that has been solidified; and
forming the second aluminum-containing metal layer that is a layer obtained by irradiating the second wire fed onto the second flux layer and the second flux layer with the laser beam, melting the second wire and the second flux layer, and solidifying the second wire and the second flux layer,
processes from the applying the liquid flux to the forming the second aluminum-containing metal layer are repeatedly performed, and
an output of the laser beam in the forming the second aluminum-containing metal layer is lower than an output of the laser beam in the layering the first aluminum-containing metal layer.

4. The additive manufacturing method according to claim 3, wherein in the heating the liquid flux applied to the underlying layer, the second flux layer is formed by blowing hot air to the liquid flux, irradiating the liquid flux with the laser beam, or bringing an object having a temperature higher than or equal to a solidification temperature of the liquid flux close to the liquid flux.

5. The additive manufacturing method according to claim 1, wherein the first wire is a wire made of metal containing aluminum and the flux, and the second wire is a wire made of metal containing aluminum and not containing the flux.

6. The additive manufacturing method according to claim 1, wherein in the layering the first aluminum-containing metal layer and the layering the one or more second aluminum-containing metal layers, a current is applied to the wire to heat the wire.

7. The additive manufacturing method according to claim 1, wherein in the layering the first aluminum-containing metal layer and the layering the one or more second aluminum-containing metal layers, the laser beam is used, the laser beam being shaped to have a homogeneous intensity distribution by increasing a beam diameter of a laser beam oscillated from a laser oscillator.

8. The additive manufacturing method according to claim 7, wherein the laser oscillator is a semiconductor laser.

9. The additive manufacturing method according to claim 1, wherein in the layering the first aluminum-containing metal layer and the layering the one or more second aluminum-containing metal layers, a temperature of a machining point that is an irradiation position of the laser beam is measured, and in a case where the temperature of the machining point is higher than a predetermined reference value, an output of the laser beam is reduced.

10. The additive manufacturing method according to claim 1, wherein in the layering the first aluminum-containing metal layer and the layering the one or more second aluminum-containing metal layers, a load received by the wire from the underlying layer is measured, and in a case where the load is larger than a predetermined reference value, a feed rate of the wire is changed, or relative positions of the wire and the base material are changed.

11. The additive manufacturing method according to claim 6, wherein in the layering the first aluminum-containing metal layer and the layering the one or more second aluminum-containing metal layers, a current flowing through the wire is measured, and in a case where a measurement value of the current is lower than a predetermined reference value, at least one of a process of reducing an output of the laser beam, a process of increasing a feed rate of the wire, or a process of reducing a current applied to the wire is performed.

12. The additive manufacturing method according to claim 6, wherein in the layering the first aluminum-containing metal layer and the layering the one or more second aluminum-containing metal layers, a voltage applied to the wire is measured, and in a case where a measurement value of the voltage is higher than a predetermined reference value, at least one of a process of reducing an output of the laser beam, a process of increasing a feed rate of the wire, or a process of reducing a current applied to the wire is performed.

13. The additive manufacturing method according to claim 6, wherein
in the layering the first aluminum-containing metal layer and the layering the one or more second aluminum-containing metal layers,
from image data obtained by imaging a region including a machining point that is an irradiation position of the laser beam, a position of a tip of the wire and a position of the machining point are acquired,
a load received by the wire from the underlying layer is measured, and
at least one of an output of the laser beam, a feed rate of the wire, or a current applied to the wire is adjusted depending on the position of the tip of the wire with reference to the machining point and a magnitude of the load with respect to a predetermined reference value.

14. The additive manufacturing method according to claim 6, wherein in layering the first aluminum-containing metal layer and the layering the one or more second aluminum-containing metal layers, a temperature of a tip of the wire is measured, and in a case where the temperature of the tip of the wire is higher than a predetermined reference value, at least one of a process of reducing an output of the laser beam, a process of increasing a feed rate of the wire, or a process of reducing a current applied to the wire is performed.

15. An additive manufacturing apparatus which performs the additive manufacturing method according to claim 1 comprising:
a stage on which a base material is to be placed;
a material feed unit to feed a wire made of metal containing aluminum;
an irradiation unit to perform irradiation with a laser beam;
a flux application unit to apply a liquid flux;
a heating unit to dry the liquid flux; and
control circuitry, wherein
the control circuitry
controls the flux application unit so as to apply the liquid flux to the base material made of metal containing iron on the stage,
controls the heating unit so as to heat the liquid flux applied onto the base material to form a flux layer,
controls the material feed unit so as to feed the wire onto the flux layer, and controls the irradiation unit so as to form a first aluminum-containing metal layer obtained by melting the wire and the flux layer without melting the base material by irradiation with the laser beam and solidifying the wire and the flux layer, and
after formation of the first aluminum-containing metal layer, controls the material feed unit so as to feed the wire onto the underlying layer, and controls the irradiation unit so as to form one or more second aluminum-containing metal layers obtained by melting the wire by irradiation with the laser beam and solidifying the wire.

16. An additive manufacturing apparatus which performs the additive manufacturing method according to claim 2 comprising:
a stage on which a base material is to be placed;
a first material feed unit to feed a flux-containing metal wire that is a wire containing aluminum and a flux;
a second material feed unit to feed a metal wire that is a wire containing aluminum;
an irradiation unit to perform irradiation with a laser beam;
a flux application unit to apply a liquid flux;
a heating unit to dry the liquid flux; and
control circuitry, wherein
the control circuitry
controls the first material feed unit so as to feed the flux-containing metal wire onto the base material made of metal containing iron on the stage, and controls the irradiation unit so as to form a first aluminum-containing metal layer obtained by melting the flux-containing metal wire by irradiation with the laser beam and solidifying the flux-containing metal wire, and
after formation of the first aluminum-containing metal layer, controls the second material feed unit so as to feed the metal wire onto the underlying layer, and controls the irradiation unit so as to form one or more second aluminum-containing metal layers obtained by melting a part of the underlying layer and the metal wire by irradiation with the laser beam, and solidifying the part of the underlying layer and the metal wire.

17. The additive manufacturing apparatus according to claim 15, further comprising:
a hot wire power supply to apply a current between the wire and the base material;
a temperature measurement unit to measure a temperature of a machining point that is an irradiation position of the laser beam;
a load measurement unit to measure a load applied to the wire;
a circuit tester to measure a current flowing through the wire or a voltage applied to the wire;
an imaging unit to image a region including the machining point; and
learning circuitry, wherein
the learning circuitry includes:
data acquisition circuitry to acquire learning data including sensing data of the additive manufacturing apparatus and manufacturing result data, the sensing data of the additive manufacturing apparatus including at least one of a temperature of a tip of the wire during a manufacturing process and a temperature of the tip of the wire before the manufacturing process acquired from the temperature measurement unit, a current flowing through the wire or a voltage applied to the wire acquired from the circuit tester, a position of the tip of the wire extracted from image data acquired from the imaging unit, or a load applied to the wire acquired from the load measurement unit, and the manufacturing result data indicating a result when a manufacturing process is performed by the additive manufacturing apparatus by using a condition obtained by the sensing data; and
model generation circuitry to generate, by using the learning data, a learned model for inferring manufacturing result prediction information that is a prediction result of a manufacturing process performed by the additive manufacturing apparatus from the sensing data of the additive manufacturing apparatus.

18. The additive manufacturing apparatus according to claim 15, further comprising:
a hot wire power supply to apply a current between the wire and the base material;
a temperature measurement unit to measure a temperature of a machining point that is an irradiation position of the laser beam;
a load measurement unit to measure a load applied to the wire;
a circuit tester to measure a current flowing through the wire or a voltage applied to the wire;
an imaging unit to image a region including the machining point; and
inference circuitry, wherein
the inference circuitry includes:
data acquisition circuitry to acquire sensing data of the additive manufacturing apparatus including at least one of a temperature of a tip of the wire during a manufacturing process and a temperature of the tip of the wire before the manufacturing process acquired from the temperature measurement unit, a current flowing through the wire or a voltage applied to the wire acquired from the circuit tester, a position of the tip of the wire extracted from image data acquired from the imaging unit, or a load applied to the wire acquired from the load measurement unit; and
inference circuitry to, by using a learned model for inferring manufacturing result prediction information that is a predicted value of a manufacturing result of the additive manufacturing apparatus from the sensing data of the additive manufacturing apparatus, output the manufacturing result prediction information from the sensing data input from the data acquisition circuitry.

19.-20. (canceled)

21. An additive manufactured object, wherein a plurality of types of metals are joined, an intermetallic compound is formed at a joint portion, and a thickness of the intermetallic compound is 2 microns or less.

22. A method for manufacturing the additive manufactured object according to claim 21 comprising:
applying a liquid flux to a base material made of metal containing iron;
forming a first flux layer that is a layer obtained by heating and drying the liquid flux applied to the base material;
layering a first aluminum-containing metal layer that is a layer obtained by irradiating a first wire that is a wire made of metal containing aluminum fed onto the first flux layer and the first flux layer with a laser beam, melting the first flux layer and the first wire, and solidifying the first flux layer and the first wire; and
layering, after formation of the first aluminum-containing metal layer, one or more second aluminum-containing metal layers that are layers obtained by irradiating a second wire that is a wire made of metal containing aluminum fed onto an underlying layer with the laser beam, melting the second wire, and solidifying the second wire.

23. A method for manufacturing the additive manufactured object according to claim 21 comprising:
layering a first aluminum-containing metal layer that is a layer obtained by irradiating a flux-containing metal wire that is a wire containing aluminum and a flux fed onto a base material made of metal containing iron with a laser beam, melting the flux-containing metal wire, and solidifying the flux-containing metal wire; and
layering, after formation of the first aluminum-containing metal layer, one or more second aluminum-containing metal layers that are layers obtained by irradiating a metal wire that is a wire containing aluminum and not containing the flux fed onto an underlying layer and a part of the underlying layer with the laser beam, melting the metal wire and the part of the underlying layer, and solidifying the metal wire and the part of the underlying layer.
